(19) United States
(12) Patent Application Publication
(10) Pub. No.: US 2017/0018215 A1
(43) Pub. Date: Jan. 19, 2017

(54) ARRANGEMENTS FOR A SOFTWARE CONFIGURABLE LIGHTING DEVICE

(71) Applicant: ABL IP HOLDING LLC, Conyers, GA (US)

(72) Inventors: Mark A. BLACK, Lawsonville, NC (US); Jack C. RAINS, JR., Herndon, VA (US); David P. RAMER, Reston, VA (US); Rashmi Kumar RAJ, Herndon, VA (US); An MAO, Reston, VA (US); Ravi Kumar KOMANDURI, Dulles, VA (US); Hampton Boone MAHER, Washington, DC (US); Guan-Bo LIN, Reston, VA (US)

(21) Appl. No.: 15/210,045

(22) Filed: Jul. 14, 2016

Related U.S. Application Data
(60) Provisional application No. 62/193,870, filed on Jul. 17, 2015.

(51) Int. Cl. G09G 3/02; G02F 1/29; G02B 26/00; H05B 37/02

(52) U.S. Cl. CPC G09G 3/02; H05B 37/0209; G02F 1/29; G02B 26/005; G09G 2320/064; G09G 2320/0646; G02F 2001/294; G02B 2207/115

(57) ABSTRACT

The examples relate to various implementations of a single software configurable lighting device, installed as a panel, that offers the capability to appear like and emulate a variety of different lighting devices. Emulation includes the appearance of the lighting device as installed in the wall or ceiling, possibly both when lighting and when not lighting, as well as light output distribution, e.g. direction and/or beam shape. Specific examples in this case combine a display device with a spatial light modulator or use angled light sources in each pixel, possibly with a settable beam shaper associated with one or more of the emission pixels.

### CROSS-REFERENCE TO RELATED APPLICATION

This application claims priority of U.S. Provisional Patent Application No. 62/193,870, filed on Jul. 17, 2015 and entitled “Arrangements for a Software Configurable Lighting Device” the entire contents of which is incorporated herein by reference.

### TECHNICAL FIELD

The present subject matter relates to arrangements of lighting devices and/or operations thereof, whereby a lighting device is configurable by software, e.g. to emulate a variety of different lighting devices.

### BACKGROUND

Electrically powered artificial lighting has become ubiquitous in modern society. Electrical lighting devices are commonly deployed, for example, in homes, buildings of commercial and other enterprise establishments, as well as in various outdoor settings.

In conventional lighting devices, the luminance output can be turned ON/OFF and often can be adjusted up or dimmed down. In some devices, e.g. using multiple colors of light emitting diode (LED) type sources, the user may be able to adjust a combined color output of the resulting illumination. The changes in intensity or color characteristics of the illumination may be responsive to manual user inputs or responsive to various sensed conditions in or about the illuminated space. The optical distribution of the light output, however, typically is fixed. Various different types of optical elements are used in such lighting devices to provide different light output distributions, but each type of device has a specific type of optic designed to create a particular light distribution for the intended application of the lighting device. The dimming and/or color control features do not affect the distribution pattern of the light emitted from the luminaire.

To the extent that multiple distribution patterns are needed for different lighting applications, multiple luminaires must be provided. To meet the demand for different appearances and/or different performance (including different distributions), a single manufacturer of lighting devices may build and sell thousands of different luminaires.

Some special purpose light fixtures, for example, fixtures designed for stage or studio type lighting, have implemented mechanical adjustments. Mechanically adjustable lenses and irises enable selectable adjustment of the output light beam shape, and mechanically adjustable gimbal fixture mounts or the like enable selectable adjustment of the angle of the fixture and thus the direction of the light output. The adjustments provided by these mechanical approaches are implemented at the overall fixture output, provide relatively coarse overall control, and are really optimized for special purpose applications, not general lighting.

There have been more recent proposals to develop lighting devices offering electronically adjustable light beam distributions, using a number of separately selectable/controllable solid state lamps or light engines within one light fixture. In at least some cases, each internal light engine or lamp may have an associated adjustable electro-optic component to adjust the respective light beam output, thereby providing distribution control for the overall illumination output of the fixture.

Although the more recent proposals provide a greater degree of distribution adjustment and may be more suitable for general lighting applications, the outward appearance of each lighting device remains the same even as the device output light distribution is adjusted. There may also be room for still further improvement in the degree of adjustment supported by the lighting device.

There also have been proposals to use displays or display-like devices mounted in or on the ceiling to provide variable lighting. The Fraunhofer Institute, for example, has demonstrated a lighting system using luminous tiles, each having a matrix of red (R) LEDs, green (G), blue (B) LEDs and white (W) LEDs as well as a diffuser film to process light from the various LEDs. The LEDs of the system were driven to simulate or mimic the effects of clouds moving across the sky. Although use of displays allows for variations in appearance that some may find pleasing, the displays or display-like devices are optimized for image output and do not provide particularly good illumination for general lighting applications. A display typically has a Lambertian output distribution over substantially the entire surface area of the display screen, which does not provide the white light intensity and coverage area at a floor or ceiling height offered by a similarly sized ceiling-mounted light fixture. Liquid crystal displays (LCD) also are rather inefficient. For example, backlights in LCD televisions have to produce almost ten times the amount of light that is actually delivered at the viewing surface. Therefore, any LCD displays that are to be used as lighting products need to be more efficient than typical LCD displays for the lighting device implementation to be commercially viable.

### SUMMARY

Disclosed herein is a lighting device that, in some examples, has a matrix display; a display driver, a controllable optic array, an optic driver, a memory; programming in the memory, and a processor. The display driver is coupled to the matrix display, and in response to a first control input drives the matrix to generate light representing the image. The controllable optic array is coupled to the matrix display to optically process the image light output from the display to shape and/or redirect image light from the display. The optic driver is coupled to the controllable optic array, responsive to a second control input, to drive a state of each pixel of the controllable optic array. The processor has access to the memory and is coupled to the drivers to supply the first and second control inputs to the drivers. The programming in the memory, when executed by the processor configures the lighting device to perform functions, such as accessing an image selection and a general lighting distribution selection. Based on the image selection, via the matrix display visible through the controllable optical array, an image output is presented. Light also is emitted that has the selected general lighting distribution from at least a portion of the optic array for general illumination.

Also disclosed is another example of a lighting device having a matrix display; a pixel controllable source; a controllable optic array; a display driver; a memory including programming; a driver coupled to the pixel controllable source and the controllable optic array; and a processor. The pixel controllable source provides general illumination lighting and image lighting. The controllable optic array is coupled to the pixel controllable source to optically process the general lighting illumination from the pixel controllable source. The controllable optic array shapes and/or redirects image light from each pixel of the source. At least one of the matrix display and the pixel controllable source allow light to pass from the other. The display driver is coupled to the matrix display, and generates light representing an image in response to a first control input to drive the matrix display. The driver is coupled to the pixel controllable source and the controllable optic array, and is responsive to a second control input. The processor has access to the memory and is coupled to the drivers to supply the first and second control inputs to the drivers. The processor when executing the programming configures the lighting device to perform functions, such as accessing an image selection and a general lighting distribution selection. The lighting device, based on the image selection, generate an image output from the matrix display. The lighting device also emits light for general illumination having the selected general lighting distribution from at least a portion of the controllable optic array. The image output and the light emission are sufficiently close in time as to appear as a combined image and general lighting output within a space illuminated by the lighting device.

Another example of a lighting device that is disclosed has a pixel controllable light generation and pixel controllable spatial light distribution system, a driver, a memory, programming in the memory, and a processor. The pixel controllable light generation and pixel controllable spatial light distribution system including a number of pixels. Each respective pixel of the light generation and distribution system includes a plurality of individually controllable light generation sources, and each of the individually controllable light generation sources is configured within the respective pixel to emit light in a different angular direction. The driver is coupled to the controllable system to control, at a pixel level, light generation by the system and to control, at the pixel level, spatial distribution of the generated light. The spatial distribution is determinative of the angular direction of emitted light. The processor has access to the memory and is coupled to the driver to control driver operation. The programming in the memory when executed by the processor configures the lighting device to perform functions, such as obtaining an image selection and a general lighting distribution selection as configuration file data. Based on the image selection, the lighting device presents an image output, and simultaneously with the image output, emits light for general illumination having the selected lighting distribution.

Another example of a lighting device as disclosed herein is a lighting device having a pixel controllable light generation matrix, a pixel controllable beam shaping array, an image driver, a distribution control a memory, programing stored in the memory. The image driver is coupled to the controllable light generation matrix and the processor. The image driver controls, at a pixel level, light generation by the matrix. The distribution control driver is coupled to the controllable beam shaping array and the processor. The distribution control driver controls at a pixel level spatial distribution of the generated light. The processor has access to the memory and is coupled to the drivers to control driver operation. Upon execution of the programming by the processor, the lighting device is configured to perform functions. The functions include obtaining an image selection and a general lighting distribution selection in a configuration file. Based on the image selection, the lighting device presents an image output, and simultaneously with the image output, emits light according to control signals sent to the distribution control driver for general illumination having the selected light distribution.

An example of a lighting fixture as disclosed herein includes an image display; and means for optically, spatially modulating light output from the image display to distribute the light output of the light fixture to emulate a lighting distribution of a selected one of a plurality of types of luminaire for a general illumination application of the one type of luminaire. The modulating means further distributes the light output of the light fixture to present an image selected from a plurality of images, and the selected image is unrelated to the general illumination application. In some examples, at least one of the disclosed lighting fixture is part of a lighting device that includes a programmable controller that is connected to control the modulating means for each of the at least one lighting fixtures.

Another example of a lighting fixture as disclosed herein includes an image display, and a means for controlling a light output of the fixture including light output from the image display, to produce an illumination light in the output from the fixture having two or more performance parameters for a selected one of a plurality of types of luminaire for a general illumination application of the one type of luminaire. The controller means includes a controller coupled to control the image display and the optical spatial modulator The image display includes a light generation source and a plurality of controllable color filters responsive to control signals provided by the controller.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a high-level functional block diagram of a software configurable lighting device.

FIG. 2 is a high-level diagram of the control functions that may be implemented in a software configurable lighting device, like that of FIG. 1.

FIG. 3 is a block diagram of a first arrangement of the pixel controllable light generation and spatial light distribution system, with the spatial light distribution component(s) coupled as an overlay logically separate from the display output, and an example of an associated driver system.

FIG. 4 is a first example of the light sources, display and spatial light distribution component(s), for use in a system like that of FIG. 3.

FIG. 5 is a second example of the light sources, display and spatial light distribution component(s), for use in a system like that of FIG. 3.

FIG. 6A is a timing diagram useful in understanding a time division multiplexing approached to the display and lighting functions.

FIG. 6B is a functional diagram of an example of a time division multiplexing implementation of display and lighting functions.

FIG. 7 is a block diagram of another arrangement of the pixel controllable light generation and spatial light distribution system together with a driver, in which each light generation pixel includes multiple individually controllable sources that are angled or use optical devices to emit light in different directions, to provide at least an initial degree of beam direction selection at the pixel level.

FIGS. 8A and 8B illustrate examples of multiple individually controllable light sources angled to emit light in different directions as might be used in a system like that of FIG. 7.

FIGS. 8C and 8D illustrate examples of multiple individually controllable light sources that use one or more controllable optics to provide angled light emissions to provide light in different directions as might be used in a system like that of FIG. 7.

FIGS. 9 and 10 are examples of pixels with different numbers of controllable sources, like those of FIGS. 8A-8D that might be used in a system like that of FIG. 7.

FIG. 11 is a block diagram of another arrangement of the pixel controllable light generation and spatial light distribution system, similar to that of FIG. 7, with an added pixel controllable beam shaping array and distribution control driver.

FIGS. 12A, 12B, 12C, 13A, 13B, 14A and 14B illustrate different views of examples of electrowettable matrices that may be used to implement pixel-level selectable beam deflection and beam shaping, e.g. in a device like that of either FIG. 2 or FIG. 11.

FIGS. 15A and 15B illustrate another example of an electrowettable lens that enables a standing or moving waveform optic configuration that provides selectable beam steering and/or beam shaping, e.g. in a device like that of either FIG. 2 or FIG. 11.

FIG. 16 is a is a simplified functional block diagram of a computer that may be configured as a host or server, for example, to supply configuration information or other data to the software configurable lighting device of FIG. 1.

FIG. 17 is a simplified functional block diagram of a personal computer or other user terminal device, which may communicate with the lighting device of FIG. 1.

FIG. 18 is a simplified functional block diagram of a mobile device, as an alternate example of a user terminal device, for possible communication with the lighting device of FIG. 1.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to a software configurable lighting device that provides an image display and configurable general illumination distribution. A single software configurable lighting device, installed as a panel, offers the capability to appear like and emulate a variety of different lighting devices. Emulation includes the appearance of the lighting device as installed in the wall or ceiling, possibly both when lighting and when not lighting, as well as light output distribution, e.g. direction and/or beam shape. The software configurable lighting device displays a virtual device, the appearance of which may be selected from retrieved from a memory device or provided via a server. For example, light distributions and device aesthetics and custom light distributions may be selected by a user from an on-line catalogue. These device aesthetics and light distributions contain the configuration data to define the appearance of the virtual device, such as a troffer, a sconce, a recessed light, or the like) and the spatial modulation, e.g. beam shape shaping and/or steering, for selected illumination light output characteristics. The virtual device selected by a user from the on-line catalogue includes an appearance for the outputted light. For a typical luminaire-like appearance, the selection might specify an image of a particular lighting device (analogous to an image of a physical lighting device). The virtual device selected by a user from the catalogue also includes a spatial lighting distribution for a selected virtual device. The appearance and distribution may be selected together, e.g. to present a luminaire appearance as well as a distribution corresponding to the selected luminaire appearance. For example, a recessed light may have a light distribution that is predetermined by the physical dimensions and structure of a recessed light; and a virtual version of such a device would appear like the recessed light and distribute the illumination light output of in a manner similar to the physical version of the recessed light. Alternatively, the catalogue may allow the user to select the appearance of one lighting device and an optical output performance (e.g. intensity, color characteristic and/or distribution) of a different lighting device. However, since the examples provide virtual lighting devices, a user may select from among custom light distributions, e.g. not corresponding to any particular device. Another option is to select or design a light distribution for the selected virtual device that is different from the typical light distribution of a physical device. Continuing with the example of a recessed light, the user may want the virtual device to look like the recessed light, but output a light distribution of an overhead fluorescent lamp. The presented image, however, may not even appear like a lighting device, per se. Hence, the presented appearance of the selected luminaire on the described configurable lighting device may be disassociated from the performance parameters of the light distributed by the lighting device. In other words, the output light distribution from the lighting device presenting the image of the selected appearance does not have to conform to the physical constraints of the selected appearance. Specific examples in this case combine a display device with a spatial light modulator or use angled light sources in each pixel, possibly with a settable beam shaper associated with one or more of the emission pixels.

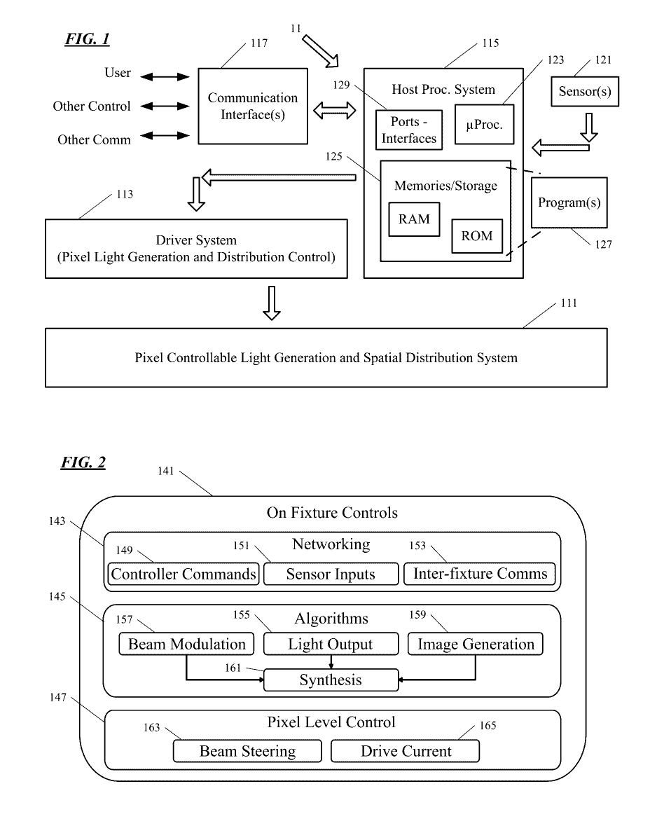

Reference now is made in detail to the examples illustrated in the accompanying drawings and discussed below. FIG. 1 illustrates a high-level functional block diagram of a lighting device, including high layer logic and communications elements, one or more drivers and a pixel controllable light generation and spatial light distribution (spatial modulation) system configured to simultaneously provide general illumination and display functionalities.

As shown in FIG. 1, the lighting device 11 includes a pixel controllable light generation and pixel controllable spatial light distribution system 111, a driver system 113, a host processing system 115, one or more sensors 121 and one or more communication interface(s) 117. Apparatuses implementing functions like those of device 11 may take other forms. In some examples, some components attributed to the lighting device may be separated from the pixel controllable light generation and spatial distribution system 111. For example, an apparatus may have all of the above hardware components on a single hardware device as shown or in different somewhat separate units. In a particular example, one set of the hardware components may be separate d from system 111, such as the host processing system 115 and may run several systems, such as the driver system 113 from a remote location. Also, one set of intelligent components, such as the microprocessor 123, may control/drive some number of driver systems 113 and/or light generation and distribution systems 111.

In an example, the processor 123 receives via one or more of communication interfaces 117 a configuration file that indicates a user selection of a virtual luminaire appearance and a light distribution to be provided by device 11. The processor 123 may store the received configuration file in memories/storage 125. Each configuration file includes software control data to set the light output parameters of the software configurable lighting device with respect to light intensity, light color characteristic and spatial modulation. The respective light output parameters set the output for the image display and general lighting distribution. The processor 123 by accessing programming 127 and using software control data in the memory 125 controls operation of the driver system 113 and other operations of the lighting device 11. For example, the processor 123 obtains an image selection of a luminaire and a general lighting distribution selection as software control data from a configuration file. Using the software control data, the processor 123 controls the driver system 113 to present, via the controllable system 111, an image output based on the image selection. The processor 123 also controls the driver system 113, based on the software control data, to emit light for general illumination having the selected light distribution. The selected light distribution may be a custom light distribution disassociated from the selected appearance image or may be a light distribution commonly associated with a selected luminaire.

The controllable system 111 includes controllable light source(s) and spatial modulators. At this time it may be appropriate to explain some of the terms that will be frequently referenced throughout the discussion of examples. For example, the light sources in the controllable system are arranged as a matrix of pixel light sources. A pixel light source electrically controllable with respect to one or more light output parameters comprising light intensity or light color characteristic. In some examples, each of the pixel light sources are individually controllable in response to control signals from the driver system 113.

The source may use a single light generator and an intermediate pixel level control mechanism. For example, the light generator may be a backlight system, and the pixel level control of intensity and color characteristics may be implemented with an liquid crystal display (LCD) type pixel matrix. The backlight may utilize one or more emitters and a waveguide or other distributor to supply light to the controllable pixels of the LCD matrix. As another example, the lighting device may use a source similar to a projection TV system, e.g. with a modulated light generation device or system and a digital micro-mirror (DMD) to distribute light modulated with respect to intensity and color characteristic across the projection surface. In the projection example, the source pixels are pixels formed on the projection surface. Other examples below utilize individual source pixels that directly incorporate light emitters within each controllable source pixel.

The spatial modulators utilize components usable to provide the light distribution modulation functions. such as pixelated light source control, multi-color light source control, and thermal mechanical control functions. The spatial modulators may incorporate one or more technologies such as micro/nano-electro-mechanical systems (MEMS/NEMS) based dynamic optical beam control that may be active control using one or more controllable lensing, reflectors and mirrors; electrowetting based dynamic optical beam control; microlens based passive beam control; passive control using segment control (X-Y area and pixels), holographic films, and/or LCD materials. Of course, these modulation technologies are given by way of non-limiting examples, and other modulation techniques may be used.

The spatial modulators also may be arranged as a matrix of pixels in which a pixel spatial light modulator is optically coupled to process light from one or more pixels of the pixel light source. Each pixel spatial light modulator, for example, is configured to be electrically controllable with respect to at least one of beam shape or beam distribution (i.e. steering) of light from the pixel light source. In some of the examples, the individual pixel spatial modulators in the spatial modulator array are also individually controllable in response to control signals from the driver system 113. The number of pixel light sources in the light source matrix of pixels does not have to correspond to the number of pixel spatial modulators in the spatial modulator array of pixels. For example, the number of pixel light sources may be 790,000 and the number of pixel spatial modulators in the spatial modulator array of pixels may be 200000 (i.e., a ratio of 4 to 1). Alternatively, the light source matrix of pixels may be a single (i.e., one) light source that provides light to the spatial modulators. In other examples, the ratio of light source pixels to spatial modulator pixels may be 1:1, 1:4, 2:1, 1:2, 3:1 or some other ratio that provides desired functionality and features.

The spatial modulators (not shown in this example) are controllable at the individual pixel levels to control a spatial distribution of light generated by one or more pixel light sources. In some examples, a pixel includes both a light source pixel and a spatial modulation pixel. There can also be examples where a combination of pixel matrices may be combined for different image generation and general illumination purposes. Spatial distribution, also referred to as angular distribution, spatial modulation, and/or light distribution, refers to spatial characteristic(s) of the output of light from a lighting device.

Where there is a source pixel corresponding to each spatial modulator pixel, or each pixel includes both a controllable source and a spatial modulator each of the combination of the source and the spatial modulator may be thought of a one combined pixel. In such cases, the pixel spatial light modulator(s) of the controllable system 111 in some examples, is configured to process light from the light source of the pixel and is electrically controllable in response to commands from the processor with respect to at least one of beam shape or beam distribution of light from the pixel light source. For example, the processor 123 by accessing programming 127 in the memory 125 controls operation of the driver system 113 and other operations of the lighting device 11 via one or more of the ports and/or interfaces 129. In the examples, the processor 123 processes data retrieved from the memory 123 and/or other data storage, and responds to light output parameters in the retrieved data to control the light generation and distribution system 111. The light output parameters may include light intensity, light color characteristics, spatial modulation, spatial distribution and the like.

Spatial distribution is influenced by different control parameters related to the manner in which generated light leaves the spatial modulator pixel, such as the angle (also referred to as beam steering), a beam shape, time period, and the like. The generated light may also take the form of light for general illumination, such as task lighting, area lighting, focal point lighting (e.g., illuminating a painting on a wall or a niche), mood lighting, and the like, as well as image generation. Image generation may be the generation of a real-world scene, such as clouds, lighting device, objects, colored tiles, photographs, videos and the like, or computer-generated images, such as graphics and the like. In other examples, the image will be a representation of or include a representation (with surrounding other imagery) of a discernible lighting device. The lighting device image, for example, may depict a conventional fixture or type of actual luminaire.

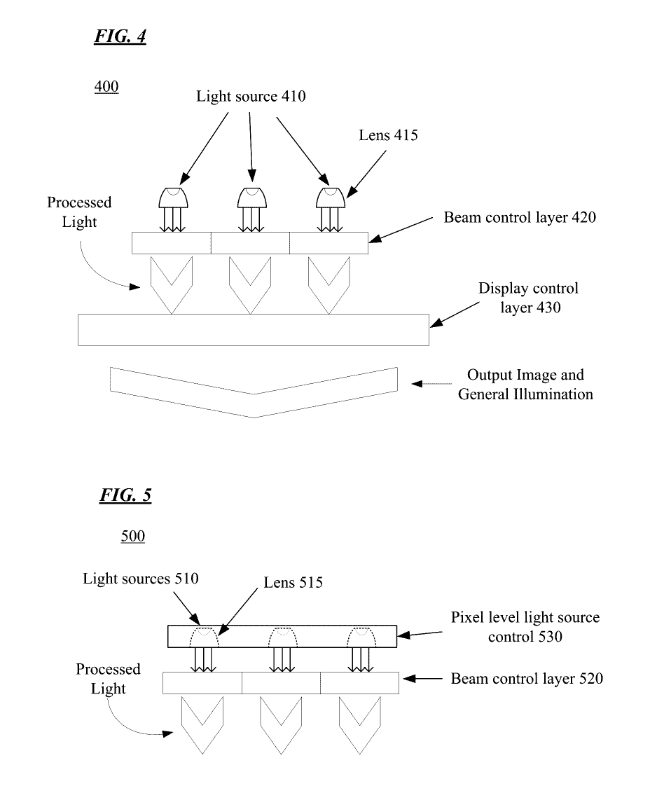

Examples of different arrangements of the light source pixels and the spatial modulator pixels are described in more detail with reference to FIGS. 4-14B. For example, a light source pixel in the matrix of light source pixels includes at least one pixel light source. In other examples, a pixel may be an integrated pixel that includes at least one pixel light source and at least one pixel spatial light modulator, and that are responsive to control signals.

Examples of a pixel light source include planar light emitting diodes (LEDs) of different colors; a micro LED; organic LEDs of different colors; pixels of an organic LED display; LEDs of different colors on gallium nitride (GaN) substrates; nanowire or nanorod LEDs of different colors; photo pumped quantum dot (QD) LEDs of different colors; plasmonic LEDs of different colors; pixels of a plasma display; laser diodes of different colors; micro LEDs of different colors; resonant-cavity (RC) LEDs of different colors; Super luminescent Diodes (SLD) of different colors, and photonic crystal LEDs of different colors. In addition to typical cellular plasma arrays used in televisions or monitors, plasma display technologies may include: plasma tube array (PTA) display technology from Shinoda Plasma Co., Ltd. or a plasma spherical array by Imaging Systems Technology (IST) in Toledo, Ohio. As will be described in more detail with reference to FIGS. 5-14B, examples of a pixel spatial light modulators are configured to process light from the light source of the pixel and are electrically controllable with respect to at least one of beam shape or beam distribution of light from the pixel light source.

For convenience, the description of examples most often describes the chosen image or the like as a representation of one luminaire, fixture or lighting device. A single software configurable lighting device 11, however, may present representations of one, two or more luminaires or lighting devices in one display. Regardless of the selected image, sets of performance parameters may approximate output of one, two or more luminaires. Also, the selection of a luminaire representation often may include a selection of a representation for appearance around or on other parts of the device output surface. For example, consider a selection of an appearance similar to a 6-inch circular downlight type physical luminaire. The output of the software configurable lighting device 11 often is larger, e.g. 2-feet by 2-feet (2×2). In such a case, the user can select where on the 2×2 output of device 11 the representation of the selected downlight should be displayed as well as the appearance of the rest of the output (where device 11 is not showing the downlight image). The user, for a ceiling mounted example, may choose for the device 11 to display a representation of a common ceiling tile around the downlight, and if so, select features such as color and texture of the displayed tile.

In addition, the device 11 is not size restricted. For example, each device 11 may be of a standard size, e.g., 2-feet by 2-feet (2×2), 2-feet by 4-feet (2×4), or the like, and arranged like tiles for larger area coverage. Alternatively, the device 11 may be a larger area device that covers a wall, a part of a wall, part of a ceiling, an entire ceiling, or some combination of portions or all of a ceiling and wall.

Also, the examples focus on presentation and illumination performance when device 11 is emitting illumination light, i.e. as if the virtual luminaire is turned ON. However, the software configurable lighting device 11 can provide a different output for the virtual luminaire in the OFF state. For example, the device 11 may display a representation of a selected virtual luminaire in an OFF state (e.g., a darkened luminaire) and any selected surrounding area in a lower light state similar to when a physical lighting device is OFF. Other OFF state options can be implemented on device 11 via configuration information. For example, the configurable device may output any desired image or a sequence of images or video for presentation when the virtual luminaire is to be OFF. As just a few such examples, the output may represent a blank ceiling tile (as if virtual luminaire disappeared), a selected photograph, a selected image of an artwork or even a video.

The host processing system 115 provides the high level logic or “brain” of the device 11. In the example, the host processing system 115 includes data storage/memories 125, such as a random access memory and/or a read-only memory, as well as programs 127 stored in one or more of the data storage/memories 125. The host processing system 115 also includes a central processing unit (CPU), shown by way of example as a microprocessor (μP) 123, although other processor hardware may serve as the CPU.

The host processing system 115 is coupled to the communication interface(s) 117. In the example, the communication interface(s) 117 offer a user interface function or communication with hardware elements providing a user interface for the device 11. The communication interface(s) 117 may communicate with other control elements, for example, a host computer of a building and control automation system (BCS). The communication interface(s) 117 may also support device communication with a variety of other systems of other parties, e.g. the device manufacturer for maintenance or an on-line server for downloading of virtual luminaire configuration data.

The host processing system 115 also is coupled to the driver system 113. The driver system 113, which may be referred to as the pixel light generation and distribution control system. The driver system, or driver, 113 is coupled to the pixel controllable light generation and spatial distribution system (e.g., “controllable system”) 111 to control at a pixel level light generation by the controllable system 111. The driver 113 also controls the pixel level spatial distribution of the generated light.

The host processing system 115 and the driver system 113 provide a number of control functions for controlling operation of the lighting device 11.

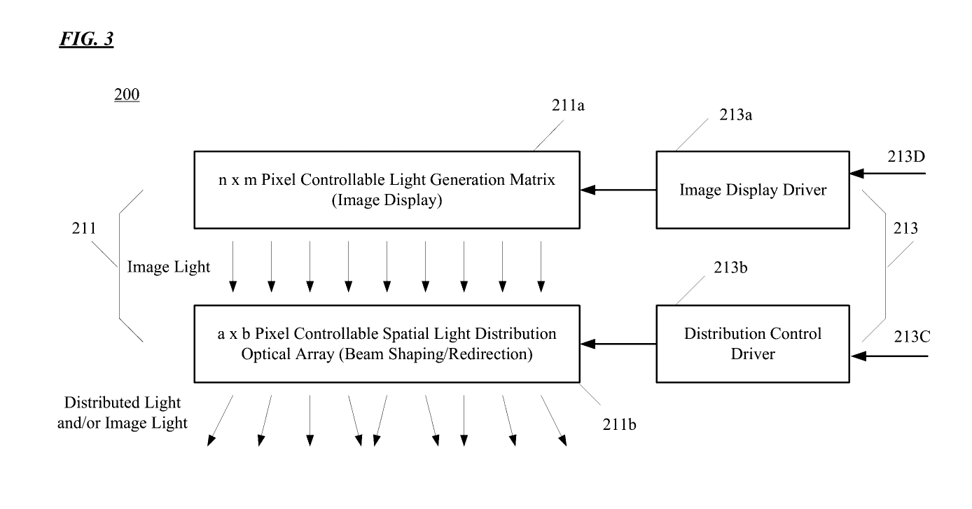

FIG. 2 is a high-level diagram of the control functions that may be implemented in a software configurable lighting device, like that of FIG. 1. For example, the On Fixture Controls 141 of the host processing system 115 and the driver system 113 encompass three functional areas of networking 143, algorithms 145 and pixel level control 147. Different aspects of each of the three functional areas may overlap into other functional areas, for example, some of the pixel level control 147 may be implemented at, or limited at, the networking 143 functional area. But for the ease of explanation, it will be presumed that the different functions are distinct and confined to the respective functional area.

The networking functional area 143 includes controller commands 149, sensor inputs 151 and inter-fixture communications (i.e., “comms”) 153. The inter-fixture comms 153 accommodates communications with controllers, such as microprocessor 123, sensor(s) 121, and/or other fixtures/devices. The processor 123 may parse commands in order to provide appropriate inputs to algorithms of the algorithms functional area 145.

The algorithms functional area 145 includes beam modulation 157, light output 155, and image generation 159, all of which are inputs into a synthesis function 161. For example, the beam modulation 157 algorithm may facilitate calculation of control settings for elements of the controllable system 111. The light output 155 algorithm may facilitate calculation of drive current settings to be generated by the driver system 113 for each pixel to achieve a desired overall light output. For example, the desired light output may have a desired correlated color temperature (CCT), intensity, and quality, such as color rendering index (CRI), R9 color rating or the like. The image generation 159 algorithms are used to calculate pixel settings to generate an image. The beam shape, light quality and image generation algorithms provide respective output parameter values to the synthesis function 161 algorithms. The synthesis function 161 algorithms use the respective output parameter values of the beam shape, light quality and image generation algorithms to produce the desired overall fixture settings of the lighting device 11. The synthesis function 161 algorithms may utilize time division multiplexing or the like, and may account for time or event based parameter values to implement certain effects, such as fading, contrast enhancement, image blurring or the like.

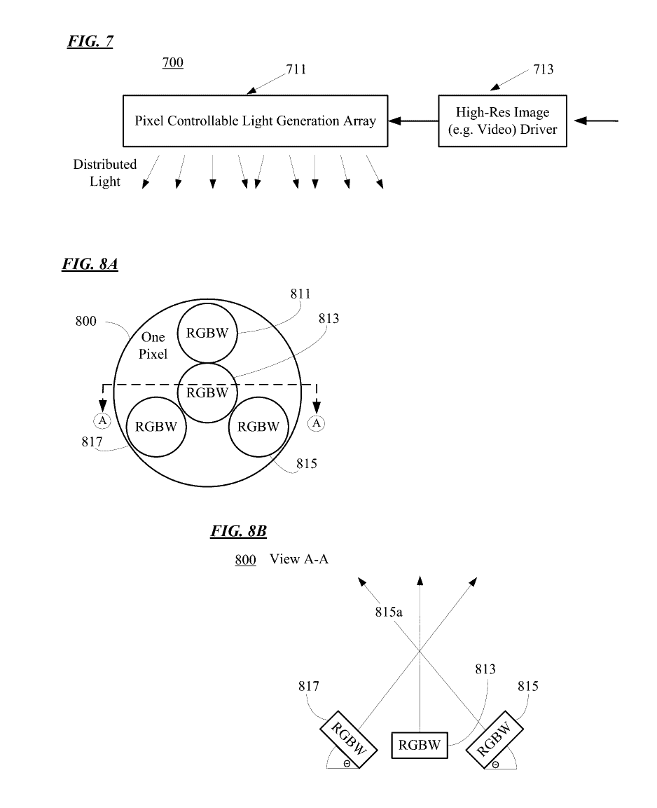

The pixel level control functional area 147 includes beam steering 163 and drive current 165 functions. For example the beam steering function 163 may allow independent control over individual beam steering elements, and controls may include X, Y or angular directional spatial distribution and/or focus adjustments for each element. Examples of the directional spatial distribution and focus adjustments are discussed in more detail with reference to FIGS. 7A and 7B.

In some examples (not shown), different configurations of pixel matrices, such as those having different sizes and different numbers of pixels, for the light sources as well as the spatial modulators may be used. The on fixture controls 141 of FIG. 2 as executed by the host processing system 115 and the driver system 113 provide a control function to the controllable system 111. As mentioned above, the controllable system 111 in some examples includes pixel level control at both the light source pixel level and at the spatial modulation level. For example, a first controller may provide light source driver signals while a second controller may provide spatial modulation driver signals, and the first and second controllers are different from one another. Alternatively or in addition, the pixel level control functional area 147 may also control spatial multiplexing of image display and general illumination distribution light output from respective lighting devices. Spatial multiplexing allows a first set of pixels in a lighting device to be controlled to provide a selected image display while a second set of pixels may be controlled to provide a selected general illumination distribution. The respective sets of pixels, in response to control signals from a processor, may switch between outputting light for a selected image display to outputting light for a selected general illumination distribution.

FIG. 3 is a block diagram of an arrangement of a driver system and a pixel controllable light generation and spatial light distribution system and an associated arrangement of drivers. In this first example, one or more controllable spatial light distribution optic(s) in the form of an array 211b are coupled as an overlay logically separate from the display output of a light generation matrix 211a, such as an image display.

The control functionality shown is FIG. 2 will now be discussed in more detail with reference to FIG. 3. In the example shown in FIG. 3, the system 200 includes a driver system 213 and a pixel controllable light generation and spatial light distribution system 211. For example, the system 200 may be a lighting fixture that includes an image display 211a and a means 211b for optically, spatially modulating light output from the image display to distribute the light output of the light fixture to emulate a lighting distribution of a selected one of a plurality of types of luminaire for a general illumination application of the one type of luminaire.

In FIG. 3, the pixel controllable light generation and spatial light distribution system 211 includes an n×m Pixel Controllable Light Generation matrix 211a for image display and an a×b Pixel Controllable Spatial Light Distribution Optical Array 211b for emulating lighting distribution by beam shaping/redirection of light. Beam shaping may be a process of focusing or dispersing a beam of light toward or away from a beam axis. Beam redirection or steering may be a process of causing the incident light to refract or deflect from an original beam direction in another angular direction using controllable or fixed optics. The variables a, b, n and m represent the number of controllable pixels in the respective matrix 211a and array 211b. The variables a, b, n and m are integers, and may or may not be equal. For example, the variables n and m may be 1024, and the variables a and b may be 512, or n and m may each be 320, while the variable a may be 1280 and b may be 720, or the like. Said differently, there does not have to be a 1 to 1 correspondence between the number of pixels in the matrix 211a and the number of pixels in the array 211b or between the numbers of rows or the numbers of columns of the matrix and the array.

The driver system 213 includes a first driver 213a suitable to provide drive signals to the particular implementation of the light generation matrix 211a. For example, for an image display device as the matrix 211a, the driver could be a corresponding image display driver. The driver system 213 also includes a second driver 213b, such as a distribution control or optic driver. Each of the first and second drivers 213a and 213b may receive and respond to respective signals 213C, 213D from an external source (not shown in this example) such as the host processor system 115 of FIG. 1 or the like.

The n×m pixel controllable light generation matrix 211a, for example, includes one or more light sources that generate light in response to signals from the image display driver 213a. The matrix 211a in several examples is a display matrix. For example, each of the light sources of the display type controllable matrix 211a is individually electrically controllable via the driver 213a with respect to light output parameters, such as light intensity and light color characteristics. Light color characteristics, for example, include different proportions of various light from each light source, such as red, green, blue and/or white light, as well as grayscale and/or monochromatic lighting effects. The display matrix may be implemented using a directly emissible source matrix, for example, where each display pixel includes some number of light emitting diodes (LEDs) of different color characteristics. In another display example, the controllable matrix 211a may also include one or more white light sources and selectively controllable filtering elements such as liquid crystal devices (LCDs). The selectively controllable filtering elements (not shown in this example) of the pixel controllable light generation matrix 211a receive commands, pass light of intensity and chrominance/color pixel-by-pixel as commanded, so that the matrix 211a generates a selected output image display. The filtering elements, such as red (R), green (G), or blue (B) color filters, may also respond to control signals received by the driver 213a via the input(s) 213D.

In an example, the image display driver 213a (FIG. 3) is coupled to a processor, such as the host processing system 115 (FIG. 1), and receives commands based on image selections and/or spatial distribution selections from the microprocessor 123 via an input(s) 213D. The selected image may be one or more images, such as still images or graphics, or may be a video stream. Based on the control signals provided to the pixel controllable light generation matrix 211a, the selected image is output from the pixel controllable light generation matrix 211a as image light.

Similarly, the distribution control driver 213b of the driver system 213 is also coupled to a processor, such as the host processing system 115, and receives commands, for example, based on general lighting distribution, or spatial distribution, selections from the microprocessor 123 via input(s) 213C.

In an example, the image display driver 213a receives commands for driving the pixel controllable light generation matrix 211a based on image selections from the microprocessor 123 via input(s) 213D. The selected image, for example, may correspond to a displayable representation of a selected lighting device or any image. The selected lighting device image may be an actual physical lighting device or an artist's/engineer's design for a lighting device that may not exist in the physical world. Similarly, the selected image may be an image of a real scene or a computer generated image.

For illustration purposes, the image light output by the pixel controllable light generation matrix 211a is received by the pixel controllable spatial light distribution array 211b. An example like this is discussed later with regard to FIG. 5. However, the arrangement may be reversed so that the controllable elements of the display layer may receive light from the beam control layer; and an example like this alternative arrangement is discussed later with regard to FIG. 4.

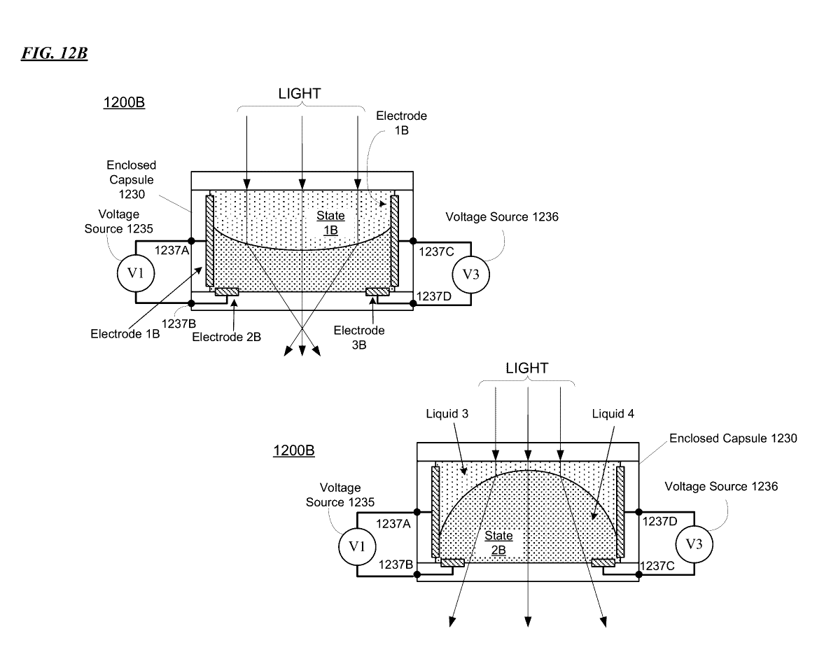

The distribution control driver 213b receives control signals related to general lighting distribution, or spatial distribution selections via the input(s) 213C. The distribution control driver 213b delivers driving signals based on the received control signals to the pixel controllable spatial light distribution optical array 211b. In response to the received driving signals, the pixel controllable spatial light distribution optical array 211b provides the selection spatial distribution of general illumination lighting. Examples of configurations of the pixel controllable spatial light distribution optical array 211b are described with reference to other figures, such as FIGS. 12-14B. For example, the pixel controllable spatial light distribution optical array 211b may include one or more components that enable beam shaping and/or light redirection to provide a multitude of different spatial distribution patterns according to the received driving signals. As a result, the pixel controllable light generation and spatial distribution system 211 responds to control signals received from the driver system 213 to generate distributed light and/or image light presenting a selected image and a providing a selected light distribution for illumination.

In some examples, the distributed control driver 213b or a processor, such as processor 123 of FIG. 1, serves as means for controlling a light output of the fixture including light output from the image display 211a, to produce an illumination light in the output from the fixture having two or more performance parameters for a selected one of a plurality of types of luminaire for a general illumination application of the one type of luminaire. The performance parameters include, for example, two or more of light intensity, a color characteristic of light, or light output distribution for the selected type of luminaire

The system 200 is an example of a configuration of driver system 213 and pixel controllable light generation and spatial light distribution system 211. However, other configurations are envisioned as will be described herein with reference to other examples and figures.

FIG. 4 is a first example of the light sources, display and spatial light distribution component(s), for use in a system analogous to that of FIG. 3 but where the display control elements receive light processed for distribution control as modulated by the beam control layer. The light source size is not limited by the size of the pixel in a display, the light source size could be much larger than the size of the individual pixels of the display layer. Examples of a pixel light source include planar light emitting diodes (LEDs) of different colors; a micro LED; organic LEDs of different colors; pixels of an organic LED display; LEDs on gallium nitride (GaN) substrates of different colors; nanowire or nanorod LEDs of different colors; photo pumped quantum dot (QD) LEDs of different colors; plasmonic LEDs of different colors; pixels of a plasma display; laser diodes of different colors; micro LEDs of different colors; resonant-cavity (RC) LEDs of different colors; super luminescent diodes (SLD) of different colors; and photonic crystal LEDs of different colors. In addition to typical cellular plasma arrays used in televisions or monitors, plasma display technologies may include: plasma tube array (PTA) display technology from Shinoda Plasma Co., Ltd. or a plasma spherical array by Imaging Systems Technology (IST) in Toledo, Ohio.

The light sources and the display control layer are separately controllable. The system 400 provides an example of a fixture level source control approach that includes light sources 410, a beam control layer 420 and a display control layer 430. The light from light sources 410 may be focused by one or more lenses 415, shown by way of example as one lens 415 on or coupled to the light output of each light source 410. The lenses 415 may be total internal reflection (TIR) lenses or the like. In a TIR lens example, each lens 415 collimates and directs the light output from the respective light source 410 toward the beam control layer 420. Each of the respective light sources 410 may be driven by a signal from a driver circuit responsive to output form a controller (both shown in other examples, such as driver system 113 and host processing system 115). In addition, the beam control layer 420 may be driven and/or controlled by a component similar to the pixel controllable light generation driver similar to that used to drive the pixel controllable spatial light distribution optical array 211b of FIG. 3. As shown in FIG. 4, the beam control layer 420 processes the light input from the light sources 410 by providing beam shaping and beam steering or redirection. The processed light is output from the beam control layer 420 to the display control layer 430.

The display control layer 430, for example, also responds to image display control signals from driver circuits and a controller (both shown in other examples) to provide an image display. For example, the display control layer 430 may include a number of selectively controllable color filters, such as LCD type RGB filters, that provide, an image displayed responsive to the image display control signals according to a user or other host selection. In addition, the display control layer 430 also receives control signals that cause the display control layer 430 to emit light according to a selected spatial light distribution pattern. For example, the display control layer 430 displays image information when turned ON, but when turned OFF, the display control layer 430 does not occlude the light output for general illumination from the beam control layer 420. As a result, the light sources 410 provide lighting for both the image display and for general illumination. Such ON/OFF operation of the layer 430 may apply to the entire display control layer 430 of may apply to groups of or individual pixels of the display control layer 430.

For example, the beam control layer 420 may receive beam shaping control signals indicating task lighting is the general illumination selected for generation by system 400. The beam control layer 420 in order to provide the task lighting may cause a spot light spatial light distribution to be generated for task lighting, which is then output to the display control layer 430. The display control layer 430 is controllable to provide both general illumination as well as an output image. Examples of the control of the display control layer are explained with reference to other figures.

An alternative to the fixture level source control approach described with reference to FIG. 4 is a pixel level source control approach. Examples of this approach also use light sources and a beam control layer.

FIG. 5 is a second example of the light sources, display and spatial light distribution component(s), for use in a system like that of FIG. 3. In the pixel level source control approach of FIG. 5, the system 500 includes light sources 510, a pixel level light source control 530 for image display, and a beam control layer 520 for beam shaping and deflection. The light source 510 includes a lens 515, such as a TIR lens, and receives control signals from the pixel level light source control 530. For example, the light sources 510 are coupled to components, such as drivers (not shown), of the pixel level light source control 530. Each light source 510 is aligned with a pixel and limited by the size of each pixel. In some examples, the size of each light source 510 may be smaller than 1 millimeter (mm), and in other examples, much smaller than 1 mm. In an example, the light source 510 is a collimated light source that is much smaller than 1 mm. The light sources 510 may be used as an image display by direct control at the pixel level of each light source 510, similar to an organic light emitting diode (OLED). To provide the pixel level control, the pixel level light source control 530 is configured to provide control signals received from a controller (not shown) for each of the respective light sources 510 according to an image selected for presentation. In addition, the respective light sources 510 are also controllable via the pixel level light source control 530 to provide light for general illumination according to selected spatial distribution pattern(s). In order to provide the selected spatial distribution pattern(s), the controller (not shown, but similar to processor 123 of FIG. 1) also provides beam shaping and beam steering control signals to the beam control layer 520.

As shown, the beam control layer 520 processes the light input from the light sources 510 by providing beam shaping and beam steering, or deflection. The processed light is output from the beam control layer 420 for presentation to a user according to the selected spatial distribution pattern.

In an example, the light sources 510 generate light for providing an image display as well as general illumination in response to the control signals received from the pixel level light source control 530. The general illumination lighting provided by the light sources 510 is processed by components, such as beam steering and beam shaping lenses (that are described in more detail in other examples), of the beam control layer 520 in response to control signals received from the controller.

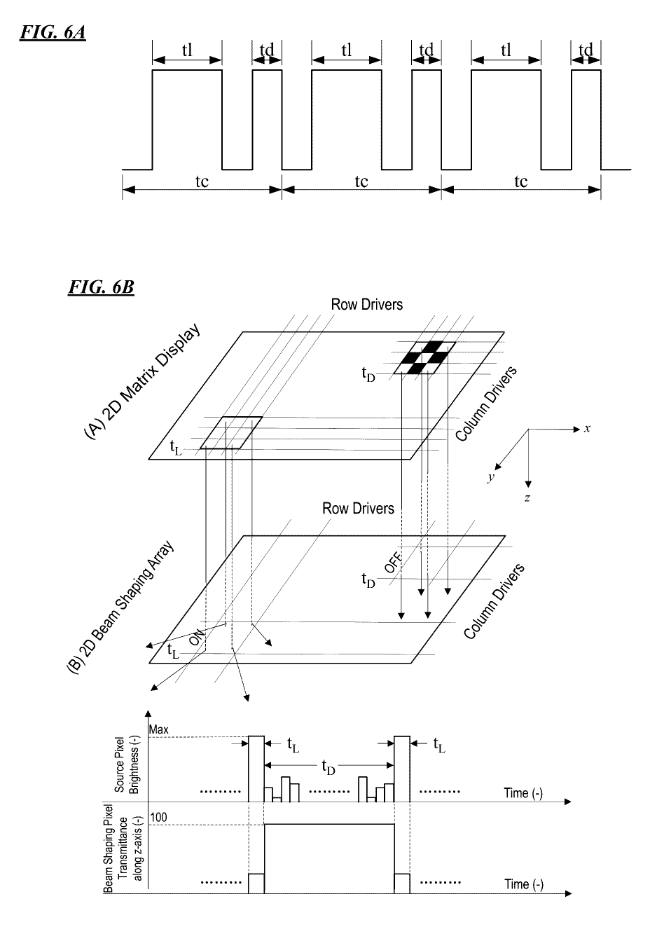

It may now be appropriate to discuss a specific example of the timing associated with providing both an image display and general illumination from a device. FIG. 6A is a timing diagram useful in understanding a time division multiplexing approached to the display and lighting functions. The driver, controller or a processor may receive timing signals for controlling the respective display and lighting functions based on a timing diagram like the simplified illustration of FIG. 6A.

In this example, the timing diagram shows a time cycle tc that includes time durations related to the general illumination lighting time duration tl and the display presentation time period td. The example timing diagram may indicate timing for a specific general lighting duration and/or a particular type of image display, and is only an example. Other timing signals may be suitable depending upon different user selections and lighting conditions selected for a space or the like. The time cycle tc may be an arbitrary time duration. The time cycle tc is likely to be a duration that does not allow the transition from general illumination lighting during time period tl to presentation of the image display during period td to be discernible (e.g., as flicker, changes in contrast of objects in the room, or the like) by a person in the space. In addition, although the time durations tc, tl and td are shown as periodic, each of the respective time durations tc, tl and td may be aperiodic to enable different general illumination distributions and image displays. A more detailed example is provided with reference to FIG. 6B.

FIG. 6B is a functional diagram of an example of a time division multiplexing implementation of display and lighting functions. The lighting devices of FIGS. 1 and 3-5 may be configured to function according to the example of FIG. 6B.

The light sources, for example, are configured to have brightness and color characteristics suitable for providing image display capability, and also have a high dynamic range to also provide selected general illumination. In an example, a lighting device includes a controller, and a pixel controllable light generation and spatial distribution matrix (as shown in FIG. 2). The pixel controllable light generation and spatial distribution matrix includes a two dimensional light source array, as the source pixel matrix, and a two dimensional beam shaping array, as the spatial modulator pixel array. Each of the respective arrays includes pixels that are responsive to control commands from the controller provided via the row and column drivers of the driver system. The two dimensional light source array is a fast switching array of light sources (e.g., micro LEDS), and the two dimensional beam shaping array is an array of beam shaping optics, such as liquid crystal diffusing film or the like. In the example, the two dimensional light source array (i.e., pixel matrix) and a two dimensional beam shaping array type of pixel matrix do not have the same pixel resolution. In other words, the two dimensional light source array type of pixel matrix has a greater resolution, i.e., a greater number of pixels, than the two dimensional beam shaping array type of pixel matrix). In the upper right corner of the light source array, a section is shown as ON, which means light is being generated by the light sources in the ON area. The beam shaping array is transparent when an OFF signal is provided to the respective pixels in the beam shaping array. As shown in FIG. 6B, the upper right corner of the beam shaping array corresponding to the upper right corner light source array is OFF, or, in other words, transparent, which allows the generated light to viewable by a user in a space in which the lighting device in located. Conversely, in the bottom left corner of the source array, the source array is operating within the illumination lighting time duration, where all the source pixels are configured for high brightness. The corresponding beam shaping array pixels are configured in the ON state to shape and steer the beam appropriately for lighting.

In the example, the time division multiplexing timing signals illustrated in the time lines at the bottom of FIG. 6B. The time period tL corresponds to the part of the switching time cycle (e.g., tC of FIG. 6A) in which the light source array performs as a general lighting device, and the time period tD corresponds to the part of the switching time cycle when the light source array performs as an image display. In the illustrated example, the source pixel brightness signal applied by the controller at the left most time tL is maximum brightness. The controller based on the timing signals outputs a signal to the respective light source pixel column and row drivers to output a maximum light output in order that the lighting device may be used as a general illumination device. At the same left most time tL, the timing signal for the beam shaping pixel transmittance in the bottom most timeline is at a low value that is interpreted by the controller to mean an OFF signal. In other words, the beam shaping array is to be transparent. In order for the beam shaping array to be transparent, the controller provides OFF control signals to the respective row and column drivers of the beam shaping array that correspond to the same pixels being controlled in the light source array. After left most time tL expires, time tD occurs and various display timing signals are provided and the respective pixel row and column drivers output control signals that drive the light sources at various intensity or brightness levels that enable an image to be displayed on the lighting device, until the left most time tL occurs. All or part of the light source pixels may simultaneously function as both display and lighting pixels based on the respective timing signals. Alternatively, particular light source pixels may function to only display images and other specific light source pixels may function to only provide general illumination. The foregoing discussion did not account for any beam shaping or beam steering control signals that may also be provided to the beam shaping array pixels, which may also be provided to the respective pixels of the beam shaping array. In addition to time division multiplexing and spatial multiplexing, lighting and display functions can be multiplexed in angle, wavelength, polarization, or in combinations of one or more of all of these approaches.

In some examples, each of the pixel spatial light modulators includes one or more electrically controllable liquid lens for beam steering or beam shaping or both. The electrically controllable liquid lens are controllable at the pixel level or the spatial modulator pixel array as will be described with reference to FIGS. 12A-14B.

FIG. 7 is a block diagram of another arrangement of the pixel controllable light generation and spatial light distribution system, in which each light generation pixel includes multiple individually controllable sources angled to emit light in different directions, to provide at least an initial degree of beam direction selection.

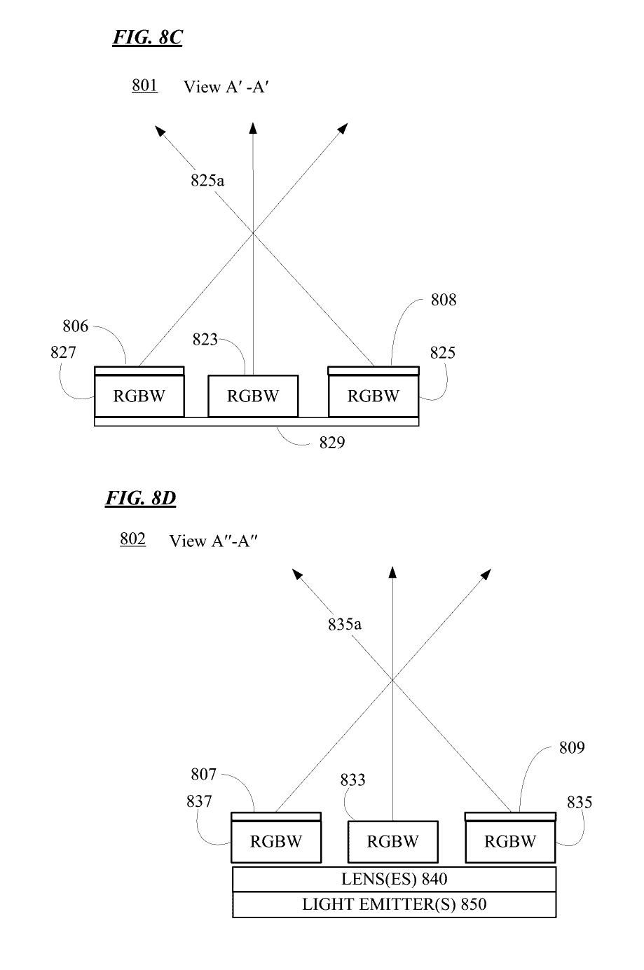

In the example of FIG. 7, the pixel controllable light generation and spatial light distribution system 700 includes structural elements that enable spatial modulation capabilities to be integrated with the light sources. The system 700 includes the pixel controllable light generation array 711 and a high resolution image driver 713, such as a video driver. The array 711 may include a number of light generation pixels that include multiple individually controllable light sources angled to emit light in different directions. In other words, each respective pixel of the light generation and distribution system 700 includes a number of individually controllable light generation sources as sub-pixel sources; and each of the individually controllable light generation sources is configured within the respective pixel to emit light in a different angular direction. For example, each respective light generation source may be integrated with other light generation sources of the same pixel at a board or chip level. Since each light generation pixel includes multiple individually controllable sources angled to emit light in different directions, both display functions and beam steering capabilities may be integrated at the board level or even on-chip. More detailed examples of the respective pixels are described with reference to FIGS. 8A and 8B.

The driver 713 is coupled to the controllable array 711 to control, at a pixel level, light generation by the system 700 and to control, also at a pixel level, spatial distribution of the distributed light by selectively actuating appropriately angled sub-pixel sources. The spatial distribution is determined based on the angular direction of emitted light. Since each respective pixel of the controllable array 711 has individually controllable light generation sources, the driver 713 is configured to provide drive signals to each of the individual light generation sources. For example, the driver system 713 may be coupled to processor, such as a host processing system 115, and receives commands based on image selections and/or spatial distribution selections from the microprocessor 123 of system 115. The driver system 713, similar to known video drivers, is configured to receive a series of control signals from the processor and, based on the control signals, distributes individual drive signals to each of the individually controllable light generation sources in the pixels for generating the selected image display and the selected spatial distribution for the general lighting illumination.

In a specific example, a processor or controller (not shown in FIG. 7) may obtain an image selection and a general lighting (spatial) distribution selection in a configuration file either by accessing a memory or by receiving via a communications interface from an external source. Each configuration file, for example, may include data to set the light output parameters of the software configurable lighting device with respect to light intensity, light color characteristic and spatial modulation. Based on the configuration file data, a controller (not shown) may generate control signals. Control signals may be generated for each of the individually controllable light generation sources of each pixel of the array 711. The controller multiplexes the generated control signals and forwards the controls signals as a control signal stream to the driver 713. The driver 713 receives the stream of control signals from a controller, and demultiplexes the control signals in order to provide individual drive signals to the individual light generation sources of the respective pixels in the controllable array 711 to generate distributed light. The generated distributed light presents, simultaneously with the selected image output, light for general illumination having the selected light distribution.

An approach to developing a configurable luminaire might utilize a display as the light source, e.g. with enhancements to improve illumination performance. For example in the system 700, an LCD type display device with a backlight type light generation source, for example, might be improved by modifications of the light generation source. The source might be modified/supplemented to increase the intensity of available light. For example, the number of light sources, whether using known types of back-lighting lamps or direct-lighting LEDs including organic LEDs (OLEDs), can be increased to increase the light output from the configurable luminaire when providing general illumination. Also, modifications may be made to the components or layers of the LCD type display device to increase the light output efficiency of LCD-type display. For example, the diffuser and/or polarizers used in a typical LCD-type display may be replaced with switchable diffusers and/or polarizers that enable the light output from the LCD-type display to be used for general illumination.

Other approaches are also envisioned, for example, the various techniques for increasing the intensity of available light output from plasma sources, such as modifying the electrode design, modifying cell shape and/or volume, changing the gas mixture or replacing the phosphor of cells may be used to provide suitable general illumination.

Another display enhancement might provide broader/smoother spectrum white light from the backlight type light generation source (e.g. instead of a source that provides fairly intense red, green and blue spikes in the spectrum of generated light). With such source enhancements, a driver, such as driver 713, might control the LCD elements, such as the switchable diffuser and/or polarizers, of the display in the pixel controllable light generation array 711 to generate an image of a light fixture or the like, with high intensity and/or high quality white light output in regions of the image corresponding to the distributed light output of the represented light fixture. Other areas of the displayed image might represent typical examples of material(s) around the fixture, e.g. a portion of a ceiling tile. Another lighting approach might use time division multiplexed control of the backlight type light generation source, for example, to provide appropriate intensity and/or color of light for image display in a first period of a recurring cycle for image display and a high intensity and/or high quality white light output in another period of each recurring cycle when the enhanced display, such as system 700, is to generate and output light for the illumination function.

The above-mentioned display enhancements may also be provided using a simpler mechanical approach that utilizes interchangeable films/diffusers/translucent sheets that are mechanically inserted and removed from in front of one of the above examples of an enhanced display. The interchangeable films/diffusers/translucent sheets may provide spatial modulation effects based on the selected general illumination distribution.

In another example, the pixel controllable light generation array 711 of FIG. 7 may be configured as an enhanced display having an array of light generation sources for providing a selected image effect with one or more light generation sources that provide a selected lighting distribution adjacent to the sources providing the selected image effect. For example, a lighting device may have a first light generation array that provides an image display with a bezel having a second light generation array that provides general illumination. Examples of light generation sources suitable for use in such an example are described in more detail below.

Different examples of the individual light generation sources are envisioned. A particular example for an individual one of the pixels of the array 711 will be described with reference to FIGS. 8A, 8B, 9 and 10. In particular, FIGS. 8A, 8B, 9 and 10 show examples of individual pixels with different numbers of angled controllable sources, as might be used in a system like that of FIG. 7. Within a given implementation of the array 711, all pixels may have the same arrangement of sub-pixel sources. Alternatively, different source pixels at different locations in the array 711 may have different arrangements, for example, so that pixels in a region at and around the center of the array 711 may have a greater number of sub-pixel sources at a larger number of different emission angles than pixels in regions of the array further from the center.

FIG. 8A shows an example of an individual light generation source 800, which is also referred to as a pixel, that may be one of a large number of light generation sources in a light generation array, such as 711. Each pixel 800 includes a number of light sources. For example, pixel 800 includes light sources 811, 813, 815 and 817. The light sources 811, 813, 815 and 817 may be LEDs, OLEDs, plasma, microLEDs, or the like. In addition, the individual light sources 811, 815, and 817 may be single colored light sources, e.g., a number of slanted red light sources, a number of slanted green light sources and so on. In the example, each of light sources 811, 813, 815, and 817 includes red (R), green (G), blue (B) and white (W) LEDs that are individually controllable to provide respective RGBW light outputs of the selected image output and general illumination lighting based on received control inputs from a controller and driver (shown in other examples). Although shown as RGBW light sources, the light sources 811, 813, 815, and 817 may be individual light sources of a single color, such as red (R) or green (G). Alternatively, additional color sources, such as amber, cyan, or the like, may be provided with RGB or RGBW LEDS in some or all of the pixels 800 of the array 711. The pixel 800 may be structured such that the light sources 811, 815 and 817 provide output light that has a preset angular distribution, in the example, about a central axis of emission corresponding to the angular emission of the central source 813.

The structure of the pixel 800 may further be explained with reference to FIG. 8B. FIG. 8B is a cross-sectional view A-A along line A-A from FIG. 8A, and illustrates an example of how the pixel 800 provides the preset angular distribution of light. As shown in view A-A of FIG. 8B, the light sources 811 (not visible in the cross-section of FIG. 8B), 815 and 817 may be configured within the pixel 800 on a slanted surface at a preset angle of Θ, which may be, for example, 10°, 12°, 20° 40° or some other appropriate angle or range of angles, such as 10° to 25°. Light source 813 may be arranged with an angle of Θ that is equal to 0°. In an example in which a lighting device is installed on a flat ceiling of a room, the pixel 800 may be part of a light generation array, such as 713, of the lighting device. The individual light source 813 of pixel 800, as shown in FIGS. 8A and 8B, is parallel to the flat ceiling and the floor of the room so that the central axis of its emitted light beam is approximately perpendicular to the flat ceiling and the floor of the room. In other words, the light source 813 is a flat light source. Meanwhile, the individual slanted light sources 811, 815 and 817 are angled or slanted at an angle Θ from the flat ceiling. The angled arrangement of light sources 811, 815 and 817 enable a lighting device to provide general illumination according to different spatial distributions, such as a wall wash or the like. For example, multiple pixels 800 in a linear array may all receive commands that turn ON light source 815 and leave light sources 811 and 817 in an OFF state. As a result, the spatial distribution of the produced general illumination may be a combination of emitted light from various directions including the direction of the light ray 815a generated by light source 815, and similar light emissions that occur from other slanted light sources, such as 817 of the pixel 800.

In operation of the RGBW example of FIGS. 8A and 8B, a driver, such as driver 713, provides driver signals to each of individual light sources 811, 813, 815 and 817 to specify an intensity of emission of each color of light available from each of those individual sources of the overall pixel 800. In response to the driver signals, the respective individual light sources 811, 813, 815 and 817 output light for general illumination according to the drive signals that account for the preset angular distribution. Similarly, the preset angular distribution of the respective individual light sources 811, 815 and 817 also contribute to the image display by generating light that combines with the light output of other light sources of pixel 800 as well as other pixels in the array.

FIG. 8C is a cross-sectional view A′-A′ along line A-A from FIG. 8A, but FIG. 8C illustrates another example of a light source, different from that of FIG. 8B, having preset optics to provide the angled light emissions from the different light sources within the pixel. The pixel 801 has a top view arrangement similar to that of FIG. 8A, and includes 823 825 and 827 as well as a light source located where light source 811 is in FIG. 8A, but that is not visible in the cross-section of FIG. 8C hat are installed on a common planar surface 829 for mounting the light generation sources. Similar to the light sources of FIGS. 8A and 8B, each of the light sources 821, 823, 825 and 827 are individually controllable to generate respective intensities of R, G, B, or W light. In this example, instead of being installed at different angles such as light sources 811, 815 and 817 of FIG. 8B, the light sources 821, 825 and 827 have light steering optics 806 and 808 installed. In other examples, the optics are controllable with respect to beam shape and/or angular beam steering, to actively implement spatial modulation. In this example, however, the optics provide beam steering but at present angle(s). The optics 806 and 808 may be an optical element such as a lens, prism, waveguide, fiber or mirror for directing light.

The optics 806 and 808 are configured to redirect generated light at one or more preset angles. Each of the optics 806 and 808 may be a microlens film, or other optical device, aligned over a respective light source 825 and 827 for providing a preset angular distribution of the light emitted from the respective light sources. An aligned microlens film may be, for example, a combination of microlens arrays (MLAs) used typically in projectors to homogenize light across a microdisplay. As a result of the microlens film or array, the spatial distribution of the produced general illumination from the pixel 801 may be any selected combination of emitted light from the various directional emissions from the sources 825 and 827, e.g. including the direction of the light ray 825a generated by light source 825 and similar light emissions from other light sources, such as 827.

FIG. 8D is a cross-sectional view A″-A″ along line A-A from FIG. 8A, and FIG. 8D illustrates another example of a pixel 802. The pixel 802 includes at least one light emitter 850, one or more lenses 840 coupled to the at least one emitter to extract and collimate light from the at least one emitter, and plurality of controllable color filters 833, 835 and 835 coupled to process collimated light output of the one or more collimating lenses to form the individually controllable light generation sources within the respective pixel. Also, an optic coupled to a respective controllable color filter 835 and 837 that redirects generated light at a preset angle. In this example, the pixel 802 includes individually controllable light sources with optics usable to provide angled light emissions from the light sources; but the sources are implemented in a different manner. The pixel 802 includes controllable light filters 833, 835 and 837 as well as a light filter located where light source 811 is in FIG. 8A, lens(es) 840 and light emitter(s) 850. The controllable light filters may be LCDs similar to those used at the pixels of an LCD type display screen. For example, a controller (shown in other drawings) is coupled to an array of pixels, such as pixel 802. The light emitter(s) 850 may be one or more light sources, such as an LED, an OLED, a plasma, an microLED, or the like, forming a backlight for one or more of the pixels 802. The light emitter(s) 850 may also be responsive to control signals received from the controller.

The light emitter(s) 850 may use a single light generator and an intermediate pixel level control mechanism. For example, the light generator may be a backlight system that utilizes one or more light emitters and a waveguide or other distributor to supply light to the controllable pixels of the LCD matrix. As another example, the lighting device may use a source similar to a projection TV system, e.g. with a modulated light generation device or system and a digital micro-mirror (DMD) to distribute light modulated with respect to intensity and color characteristic across the projection surface. In the projection example, the source pixels are pixels formed on the projection surface.

The lens(es) 840 may be total internal reflective (TR) lenses that collimate extract light from the source emitter(s) and direct collimated light to toward respective light filters. The light filters 833, 835 and 837, when suitably illuminated, may be individually controllable liquid crystal light filters that are able to output one or more colors, such as R, G, B or W, of light. The light output from the light filter, such as light filter 833, may pass directly out of the light filter 833 for further processing by the lighting device in which the pixel 802 is installed. However, light output from other light filters such as light filters 835 and 837 may be output to an optic, such as 807 and 809. The optics 807 and 809 may be an optical element such as a lens, prism, waveguide, fiber or mirror for directing light. The optics 807 and 809 are configured to redirect generated light at a preset angle, as discussed above relative to FIG. 8C. The optics 807 and 809 may be microlens film, or other optical device, such as flat shutters with slanted film and/or reflectors, that are aligned over a respective light filter 835 or 837 for providing a preset angular distribution of the light emitted from the respective light filters. An aligned microlens film may be, for example, a combination of microlens arrays (MLAs) used typically in projectors to homogenize light across a microdisplay. As a result of the microlens film or array, the spatial distribution of the produced general illumination from the pixel 802 may be a combination of emitted light from the various directional emissions from the sources 835 and 837, e.g., including the direction of the light ray 835a output by light source 835 and similar light emissions from other light sources, such as 837.

Of course, other examples of general illumination effects are also envisioned that take advantage of the angled light sources or optical devices that provide angled spatial distributions and the application of different control signals. For example, combinations of the angled emission arrangements of FIGS. 8B-8D may be used within individual pixels and/or in different pixels of an array.

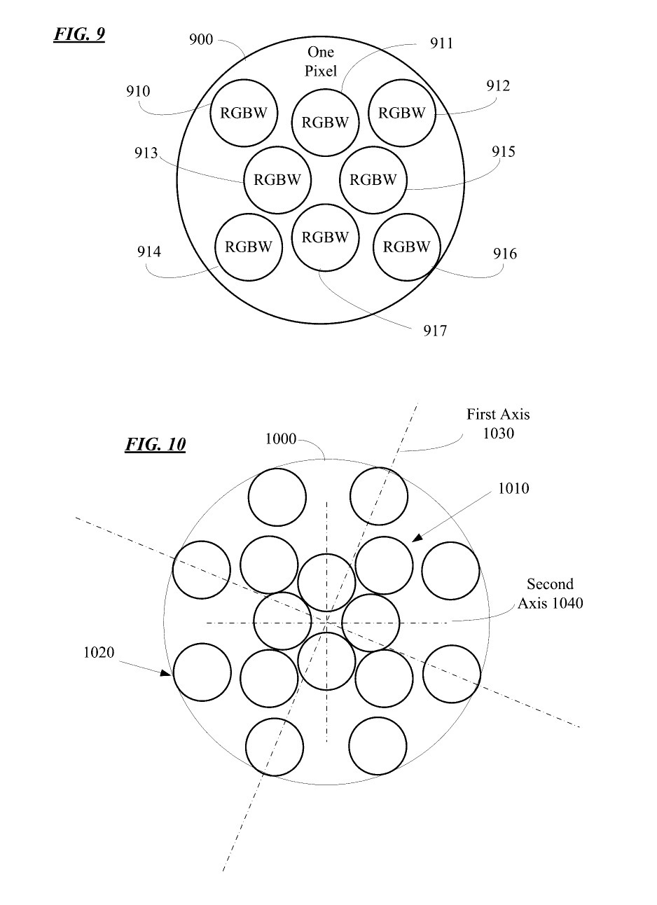

In addition, implementations of a pixel other than pixel 800 are envisioned for use with the described lighting device. For example, pixels may have different numbers of sub-pixel sources. FIG. 9 illustrates a pixel 900 including a number of “flat” individual lighting sources and a number of angled individual light sources. The pixel 900 is configured with eight individually controllable light sources 910-917. The sources 910-917 may be implemented in any of the ways described above relative to FIGS. 8B-8D. The four center light sources 911, 913, 915 and 917 may be flat light sources, while light sources 910, 912, 914 and 916 are angled light sources. The angle of light sources 910, 912, 914 and 916 may be angled away from the center of pixel 900, so that the light generated by the pixel 900 is dispersed over a wider area. Alternatively, the angle of light sources 910, 912, 914 and 916 may be angled toward the center of pixel 900, similar to the earlier examples of FIGS. 8B-8D, so that the light generated by the pixel 900 when all of the light sources are ON is focused in smaller area aligned with the center of the pixel 900. As mentioned with reference to other examples, each of the individual light sources 910-917 are individually controllable via control signals from a controller (not shown in this example). The individual control of light sources within the pixel 900 enables groups of pixels, like 900, when operating in cooperation, to provide a variety of general illumination distributions, such as focused task lighting, a wall wash, or a spot light. In addition, since the light sources are individually controllable, each pixel such as 900 may be controlled to provide both an image display (using the center sub-pixel sources 911, 913, 915 or 917) and general illumination using pixels 910, 912, 914 and 916.

In yet another example of a pixel configuration, FIG. 10 illustrates an example in which individual lighting sources are arranged along two axes, first axis 1030 and second axis 1040. The pixel 1000 includes center light sources 1010 (e.g., the light sources clustered toward the center of pixel 1000) and perimeter light sources 1020 (e.g., the six lighting sources around the perimeter of pixel 1000). The perimeter lighting sources 102 may be arranged in the first axis 1030 and may be light sources with a first preset angle, and the center light sources 1010 may be arranged in the second axis 1040, and may have a second preset angle. The first preset angle may be different from the second preset angle. For example, the first preset angle may be 10° while the second preset angle may be 2° or zero. Similar to the individual light sources of FIGS. 8A and 9, the light sources 1010 and 1020 of FIG. 10 may also be RGBW light sources, using arrangements like those in FIGS. 8B-8D. Alternatively, the light sources 1010 and 1020 for each respective pixel 1000 may be a single color, such as red or blue. In an example, the perimeter light sources 1020 may be controlled to provide image display signals and the center light sources 1010 may be controlled to provide general illumination, or vice versa. In addition, the individual light sources 1010 and 1020 may be controlled by the controller to cooperate to provide different spatial lighting distributions.

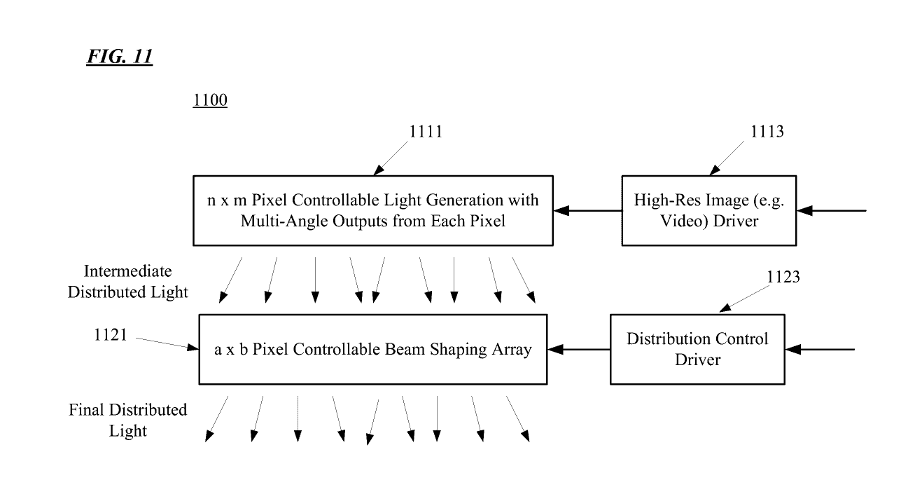

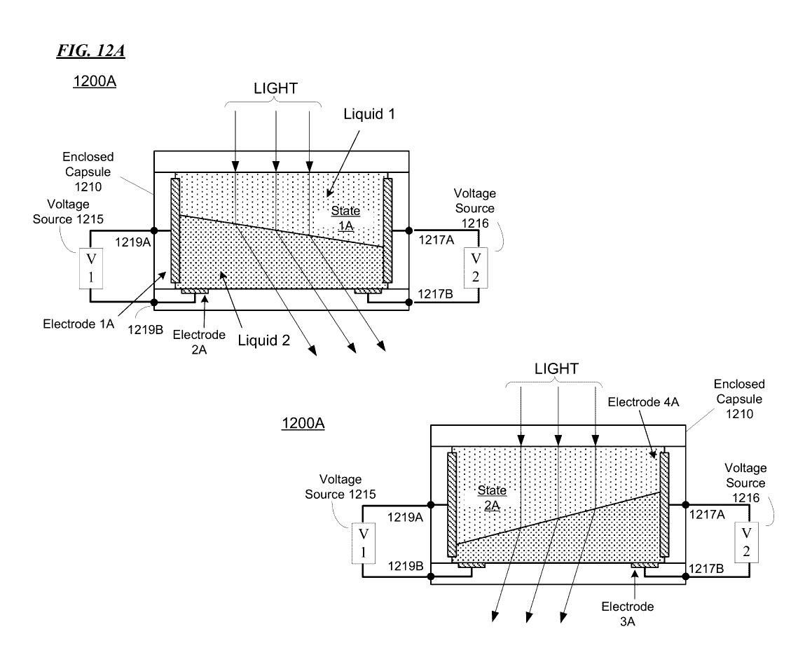

The examples of FIGS. 8A to 10 illustrate structures for a pixel having different arrangements of individually controllable and angled light sources, or different arrangements of individually controllable for use in the pixel controllable light generation array 711 in a system 700 such as shown in FIG. 7, but similar pixel structures may be used in a somewhat different system such as that shown in FIG. 11.

FIG. 11 is a block diagram of another arrangement of a pixel controllable light generation and spatial light distribution system, similar to that of FIG. 7, but with an added pixel controllable beam shaping array and an associated distribution control driver.

The pixel controllable light generation and spatial light distribution system 1100 includes structural elements that enable spatial modulation capabilities to be integrated with the light sources. For example, the system 1100 includes a pixel controllable light generation matrix 1111 (similar to the pixel controllable light generation array 711), a high-resolution image driver 1113, a distribution control driver 1123 and a pixel controllable beam shaping array 1121.

The pixel controllable light generation matrix 1111 has multi-angle outputs from each pixel. The matrix 1111 may include a number of light generation pixels that include multiple individually controllable light sources angled to emit light in a direction other than perpendicular. For example, the pixels shown in FIGS. 8A-8D may be used in the matrix 1111. In other words, each respective pixel of the pixel controllable light generation matrix 1111 includes a number of individually controllable light generation sources as sub-pixel sources in matrix 1111; and each of the individually controllable light generation sources is configured within the respective pixel to emit light in one of several preset angular directions. For example, each light generation pixel includes multiple individually controllable sources angled to emit light in different directions. In another example, each of the light generation pixels includes multiple individually controllable sources using optics to direct the emitted light in a preset angular direction. In some examples, the light generation sources may be integrated with other light generation sources of the same pixel at a board or chip level as described above with reference to FIGS. 8A and 8B. The pixel controllable light generation matrix 1111 outputs distributed light that presents the selected image display and also provides angular processing for the selected spatial distribution as general lighting illumination (both the selected image display and the general illumination are indicated as intermediate distributed light in the drawing).

The intermediate output of the selected image display and angular spatial distribution is controlled by signals received from the high resolution image driver 1113. The high resolution image driver 1113 may be a video driver, and is coupled to the controllable light generation matrix 1111 to control, at a pixel level, light generation by the system 700 and to control, also at a pixel level, the angular spatial distribution of the distributed light. The angular spatial distribution is determined based on the angular direction of emitted light. Since each respective pixel of the controllable matrix 1111 has individually controllable light generation sources, the driver 1113 is configured to provide drive signals to each of the individual light generation sources. For example, the driver system 1113 may be coupled to a system, such as a host processing system 115, and receives commands from the processor based on image selections and/or spatial distribution selections from the microprocessor 123. The received commands account for the angular light distribution capabilities of the individual light generation sources, such as 811, 813, 815 and 817 of FIGS. 8, 910, 912, 914 and 915 of FIG. 9, or 1010 and 1020 of FIG. 10, and the like, and provides control signals to the matrix 1111 to produce the selected image display, such as a troffer, and a selected spatial distribution, such as a wall wash. The light is output from the matrix 1111 as intermediate distributed light to the pixel controllable array 1121.

However, for some general lighting applications, further spatial modulation may be desirable. Hence, the example provides an additional layer of pixel-level beam shaping control. The pixel controllable beam shaping array 1121 receives the intermediate distributed light from matrix 1111. The pixel controllable beam shaping array 1121 includes controllable optics that process portions of the intermediate distributed light to provide beam shaping according to a selected spatial distribution. For example, if the selected spatial distribution is a wall wash, the beam shaping array 1121 may further process the intermediate distributed light to generate final distributed light providing the selected wall wash spatial distribution, at particular angles and beam shapes to produce a desired illumination pattern on a wall that is the target of the wall wash illumination.

The controllable beam shaping array 1121 includes a number of elements as controllable optics, which may be referred to as beam shaping pixels. The beam shaping pixel optics are individually controllable to provide either focusing or dispersion of light from the respective pixels. Examples of the beam shaping pixels include LCD pixels, electrowettable lenses, and the like. More detailed examples of the beam shaping pixels and array 1121 are described with reference to FIGS. 12 and 13A-14B.

The individually controllable pixels (not separately shown in FIG. 11) receive control signals from the distribution control driver 1123. For example, the distribution control driver 1123 may be coupled to a system, such as a host processing system 115, receive commands based on image selections and/or spatial distribution selections from the microprocessor 123 of the system 115. The pixel controllable light generation matrix 1111 and the controllable beam shaping array 1121, under control of respective drivers 1113 and 1123, cooperate to provide the selected images and/or spatial distributions. For example, the lighting device 1100 simultaneously with the image output, emits light according to control signals sent to the distribution control driver 1123 for general illumination having the selected light distribution.

FIG. 11 shows the pixel controllable light generation matrix 1111 as being an n by m array, and shows the pixel controllable beam shaping array 1121 as being a by b. The variable a, b, n, and m are integers, and may be different or the same values. For example, n and m, and a and b may all be 1024. In other words, in this example, the matrix 1111 is 1024×1024 light generation source pixels, and the array 1121 is 1024 by 1024 pixels. In other words, there is a 1:1 correspondence between the number of light generation source pixels in matrix 1111 and the number of beam shaping pixels in array 1121. However, in examples in which the light generation sources include individually controllable sources for each respective color (i.e., one pixel such as 800 dedicated for red light, one pixel dedicated for green light, one pixel dedicated for blue light and/or one pixel for white light), the beam shaping array 1121 may use fewer pixels such as 1 beam shaping pixel to accommodate the light generated by the four individual colors of the light generation sources. In other words, the number of pixel light generation sources in the matrix 1111 does not have to correspond to the number of beam shaping pixels in array 1121. For example, the number of pixel light generation sources may be 790,000 and the number of beam shaping pixels in the matrix 1123 may be 200000 (i.e., a ratio of 4 to 1). In other examples, the ratio of light source pixels to spatial modulator pixels may be 1:1, 1:4, 2:1, 1:2, 3:1 or some other ratio that provides the desired functionality and features. Examples of components usable as the controllable beam shaping pixels and matrix 1123 will now be described with reference to FIGS. 12, 13A, 13B, 14A and 14B.

FIGS. 12A-C, 13A, 13B, 14A and 14B illustrate different views of examples of electrowettable matrices that may be used to implement pixel-level selectable beam deflection and beam shaping, e.g. in a device like that of either FIG. 3 or FIG. 11.

In some examples, each of the pixel spatial light modulators includes one or more electrically controllable liquid lens for beam steering or beam shaping or both. The electrically controllable liquid lens are controllable at the pixel level or the spatial modulator pixel array. As shown in FIGS. 12A and 12B, a respective pixel of the pixel spatial modulators is controllable in response to control voltages to process light from a light source. For example, the spatial modulator pixel 1200A may process input light by deflecting (i.e., refracting) the inputted light, while the spatial modulator pixel 1200B processes input light by shaping the beam of light. In other words, each spatial modulator pixel 1200A or 1200B may act as a lens that processes input light according to control signals.

FIG. 12A illustrates an electrically controllable liquid prism lens within enclosed capsule 1210, which may also be referred to as a pixel. The ray tracings are provided to generally illustrate the beam steering and beam shaping concepts and are not intended to indicate actual performance of the illustrated electrically controllable liquid prism lens. The enclosed capsule 1210 is configured with one or more immiscible liquids (e.g., Liquid 1 and Liquid 2) that are responsive to an applied voltage from voltage source 1215. For example, the liquids 1 and 2 may an oil and water, respectively, or some other combination of immiscible liquids that are electrically controllable. The desired spatial distribution effects are provided based on liquid 1 having a higher index of refraction than the index of refraction of liquid 2. The enclosed capsule 1210, which has a physical shape of a cube or rectangular box, retains the liquids 1 and 2 to provide an electrically controllable liquid prism lens. The enclosed capsule 1210 includes terminals 1217A, 1217B, 1219A and 1219B that are coupled to electrodes 1A, 2A, 3A and 4A, respectively.

As shown in the example of FIG. 12A, the pixel 1200A has a first state, State 1A, in which the voltage source 1215 outputs a voltage V1 that is applied across terminals 1219A and 1219B and the voltage source 1226 outputs a voltage V2 that is applied across terminals 1217A and 1217B. The voltage V1 applied to electrodes 1A and 2A and voltage V2 applied to electrodes 3A and 4A causes the liquids 1 and 2 to assume the State 1A as shown on the left side of FIG. 12A. As shown, the input light is deflected to the right when pixel 1200A is in State 1A. State 1A may represent the maximum deflection angle in the indicated direction. A range of deflection angles between the angle of State 1A and perpendicular (e.g., zero degrees) may also be obtained by adjusting the applied voltage appropriately. On the bottom right side of FIG. 12A, an example illustrates the output light deflection when pixel 1200A is in State 2A. The pixel 1200A achieves State 2A when the combination of voltages V1 and V2 is applied by voltage sources 1215 and 1216. The pixel in State 2A deflects the light in a direction opposite that of when the pixel is in State 1A. State 2A may represent the maximum deflection angle in the indicated direction. A range of deflection angles between the angle of State 2A and perpendicular (e.g., zero degrees) may also be obtained by adjusting the applied voltage appropriately. Also, the pixel 1200A may achieve other states based on the input voltage, theses a third state (not shown) is an OFF state, as described with reference to FIG. 6B in which no voltage or a nominal voltage is applied that causes no deflection of the input light. In other words, the light passes directly through the spatial modulator pixel 1200A without deflection. Hence, the angle of the deflection may be manipulated by adjusting the voltages applied by voltage sources 1215 and 1216. For example, the voltages V1 and V2 may not be equal. The voltages V1 and V2 may be applied simultaneously at different values to achieve a particular state between State 1A and State 2A. Although the voltages V1 and V2 are described as being applied simultaneously, the voltage V1 and V2 may be applied separately.

Although not shown, in some examples, a switching mechanism, such as transistors, may be used to switch the applied voltages from terminals 1219A/1219B to 1217A/1217B. Note that while the orientation of the pixel 1200A shows the deflection of the light to the left and the right of the illustrated pixel 1200A, it should be understood that the pixel may be oriented so the light deflects in any direction from the bottom of the pixel.

Alternatively or in addition, more complex electrode configurations may be implemented. For example, electrodes 1A-4A are shown on different sides of enclosed capsule 1210 for the ease of illustration and description; however, additional electrodes may be on all four sides of the rectangular (or square) enclosed capsule 1210. In which case, the enclosed capsule is capable of deflecting beams in multiple directions, not just left, right, forward, and backward, but also diagonally, for example.

The spatial modulator pixel 1200B of FIG. 12B illustrates an electrically controllable lens having a beam shaping capability. The ray tracings are provided to generally illustrate the beam steering and beam shaping concepts and are not intended to indicate actual performance of the illustrated electrically controllable liquid prism lens. The pixel 1200B, like pixel 1200A, is configured with one or more immiscible liquids (e.g., Liquid 3 and Liquid 4) that are responsive to an applied voltage from voltage sources 1215 and 1216. For example, the liquids 3 and 4 may an oil and water, respectively, or some other combination of immiscible liquids that are electrically controllable. The desired spatial distribution effects are provided based on liquid 3 having a higher index of refraction than the index of refraction of liquid 4. In the illustrated example, the liquid 3 has a higher index of refraction than liquid 4. Although the enclosed capsule 1230 is shown as a rectangular box, the enclosed capsule 1230 may have the physical shape of a cube, a cylinder, ovoid or the like. The enclosed capsule 1230 retains liquids 3 and 4, and is also configured with electrodes 1B and 2B that surround the periphery of the enclosed capsule 1230. By surrounding the periphery of the enclosed capsule 1230, voltages applied to the electrodes 1B-4B cause the liquids 3 and 4 to form a lens that provides beam shaping processing of the input light. Terminals 1237A and 1237B allow voltage source 1235 to be connected to the pixel 1200B. As shown on the top left side of FIG. 12B, the voltage source 1235 applies a voltage V1 across the terminals 1237A and 1237B. In response to the applied voltages V1 and V3 the liquids 3 and 4 react to provide a concave shaped lens as State 1B. Input light from the light source (not shown) is processed based on control signals indicating the voltage to be applied by the voltage sources 1235 and 1236 to provide a shaped beam that focuses the light at a point the locus of which is electrically controllable.

The pixel 1200B is further configurable to provide beam dispersion. As shown in the bottom right side of FIG. 12B, the pixel 1200B based on applied voltages V1 and V3 forms a convex lens, shown as State 2B, that disperses the input light. In particular, the voltage source 1235 applies voltage V1 across terminals 1237A and 1237B, which is then applied to electrodes 1B and 2B. Similarly, the voltage source 1236 applies a voltage V3 that is applied across terminals 1237C and 1237D that is provided to electrodes 3B and 4B. The voltage V1 applied to electrodes 1B and 2B and the voltage V3 applied to electrodes 3B and 4B causes the liquids 3 and 4 to react to assume State 2B. Depending upon the voltages applied by voltage sources 1235 and 1236 to the respective electrodes, other states between States 1B and 2B may also be attained.

The beam steering functions of FIG. 12A and the beam shaping functions of FIG. 12B are described separately for ease of explanation; however, the functions and capabilities described and illustrated with reference to FIGS. 12A and 12B may be combined in a single electrowetting optic to provide a combined electrowetting optic that is capable of simultaneously beam steering and beam shaping, separately providing beam steering or separately providing beam shaping. By applying different voltages to the respective electrodes, the simultaneous electrically controllable beam steering and beam shaping may be provided. An example of an implementation that provides simultaneous electrically controllable beam steering and beam shaping is illustrated in FIG. 12C.

FIG. 12C illustrates an example of electrowettable lens 1200C that includes an enclosed capsule 1220 and voltage sources 1225 and 1226. The enclosed capsule 1220 includes terminals 1227A and 1227B that couple to voltage source 1225C and terminals 1227C and 1227D that couple to voltage source 1226. The terminals 1227A and 1227B are further coupled to electrodes 1C and 2C and terminals 1227C and 1227D are further coupled to electrodes 3C and 4C. The liquids 3 and 4 respond to voltages applied to the electrodes 1C-4C to provide a combination of beam steering and beam shaping functions. The electrowettable lens 1200C responds to different voltages from voltage sources 1225 and 1226 to attain the different states 1C-4C illustrated in the four different examples. The states 1C and 3C provide beam steering with focusing beam shaping, while states 2C and 4C provide beam steering but with defocusing beam shaping. The voltage sources 1225 and 1226 may apply voltages of different values including different polarities that enable the electrowettable lens 1200C to provide variations of states 1C-4C that may be used to process light according to the selected images and selected spatial modulation.

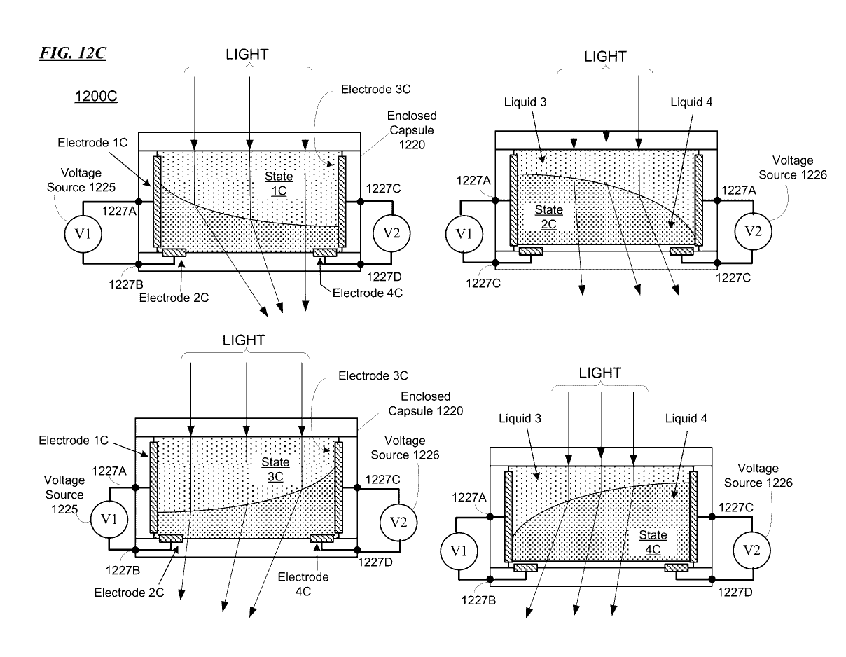

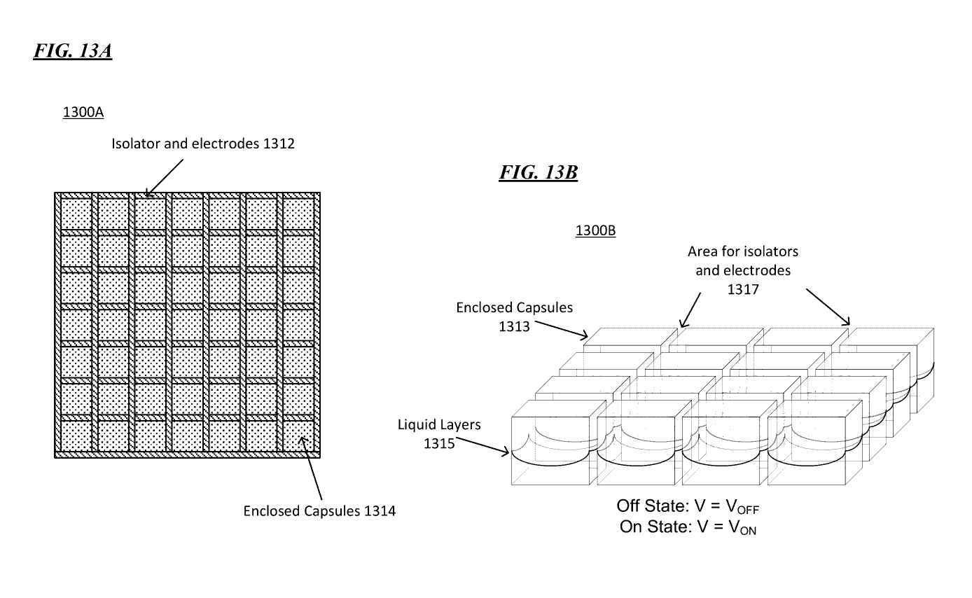

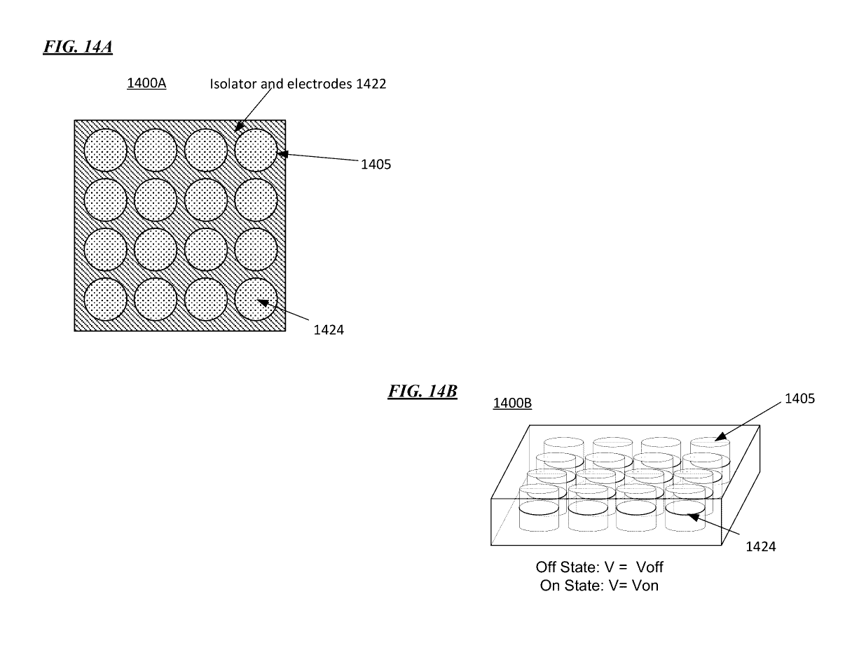

FIGS. 13A, 13B, 14A and 14B illustrate different views of pixel matrices, such as examples of electrowettable lens or prism matrices that may be used to implement pixel-level selectable beam steering and/or beam shaping, e.g. in a device like that of either FIG. 4 or FIG. 5. Each of the respective pixel matrices 13A-14B may act as a matrix of lens that processes input light according to control signals.

For example, FIG. 13A illustrates a top or bottom view of a matrix 1300A that is formed from a number of pixels, such as the pixel 1200A shown in FIG. 12A. The pixel matrix 1300A includes isolators and electrodes 1312 that surround enclosed capsules 1314. As shown in FIG. 13B, the matrix 1300B includes a number of enclosed capsules 1313, which have liquid layers 1315, for example, similar to the liquids 1 and 2 of FIG. 12A or liquids 3 and 4 of FIG. 12B. In the example of FIG. 13B, the different pixel states, such as States 1B and 2B shown in FIG. 12B, are attained by applying voltages. As shown in FIG. 13B, the Off state, which may correspond to State 1B, is achieved by an applied voltage of VOFF volts, while the On state (not shown) that corresponds to State 2B of FIG. 12B is achieved by applying a voltage of VON volts. Of course, the voltages VON and VOFF may be any voltage and/or polarity, such as ±10 volts or ±10 millivolts, suitable for achieving the desired beam steering (e.g., angular modulation) or beam shaping. Said differently, the control signal may be analog so the control of the beam shaping or beam steering may extend over a range of focal lengths (e.g., narrow focused beam to wide dispersed beam) or over a range of angles (e.g., zero degrees, or straight out, from the lighting device to an angle that may be up to approximately 90 degrees from the vertical, or even greater than 90 degrees depending upon the geometry of the electrowettable lens or lighting device).

While FIG. 13B shows pixel states similar to those achievable by individual pixel 1200B, a pixel matrix similar to pixel matrix 1300A and/or pixel matrix 1300B may be used to generate the liquid lens prisms of pixel 1200A. As mentioned above, the electrodes 1227A and 1227B may surround the perimeter of the enclosed capsule 1220. Similarly, the electrodes 1312 may also surround individual pixels in the matrix 1300A.

Another example of a pixel matrix is matrix 1400A shown in FIG. 14A. The pixel matrix 1400A includes isolators and electrodes 1422 that surround enclosed capsules 1405. The individual pixels, in this example, that correspond to enclosed capsules 1405 of matrix 1400C may be circular or elliptical enclosed capsules that contain liquid layers 1424. The pixel matrix 1400A includes isolators and electrodes 1422 that surround enclosed capsules 1405. FIG. 14B shows a cross-sectional view of a matrix 1400B. As shown in FIG. 14B, the matrix 1400B includes a number of enclosed capsules 1405, which have liquid layers 1424, for example, similar to the liquids 1 and 2 of FIG. 12A or liquids 3 and 4 of FIG. 12B. The pixels in the matrix 1400B provide pixel lens prisms that are individually electrically controllable, or that may be controllable in groups, such as 2-4 individual pixels may be responsive to a first control signal while other pixels are responsive to second, third and so on commands. Each of the pixels may respond in either the same manner to an applied voltage or differently based on the type of enclosed liquids or shape of the individual pixels.

Similar to the discussion with respect to FIGS. 12A and 12B, the voltage applied to the electrodes of the isolators and electrodes 1422 in FIG. 14A causes a response in the respective pixels 1405 in order for a desire output light image and general illumination distribution to be attained. For example, the individual pixels in the matrix 1400B of FIG. 14B have an OFF state that is attained by applying a voltage VOFF to the electrodes 1422. The isolators of the isolators and electrodes 1422 serve to isolate the other pixels both electrically and optically from spurious light from adjacent light sources to the respective pixels. The OFF state may be a state in which light from a light source passes through the respective pixels of the matrix 1400D without being processed without controlled deflection of the light from the light source. Alternatively, the input light may be processed according to a predetermined state, such as states 1A, 2A, 1B or 2B of FIGS. 12A and 12B, that the respective pixel attains when a voltage is applied. Similarly, the pixel may also have an ON state in which the applied voltage is VON. Different pixels in the pixel matrices 1300A and 1300B as well as 1400A and 1400B may have pixels at different states (as described with reference to FIGS. 6 and 6B above) based on different applied voltages, which may be a range of voltages not only specific voltages, such as VON or VOFF. The range of ±10 volts mentioned above may include a VOFF of 0 volts, but have a range of VON settings, such as at both −10 volts and +10 volts, between the voltages of −3 volts and +5 volts, or some other settings.

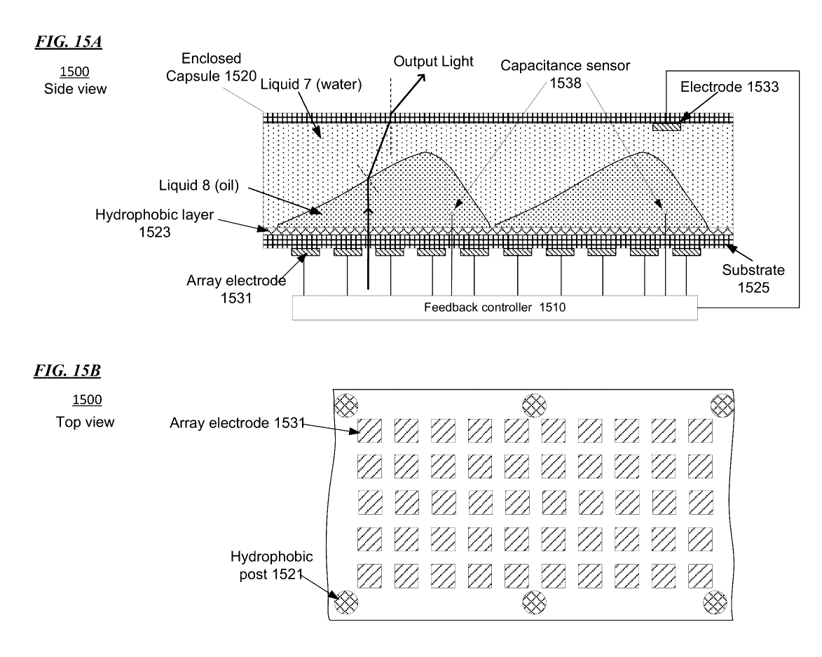

Another example of an electrowettable lens is shown in FIGS. 15A and 15B. The electrowettable lens illustrated in FIGS. 15A and 15B is able to provide a standing or moving wave configuration as illustrated in FIG. 15A. The electrowettable 1500 includes a feedback controller 1510, an enclosed capsule 1520, array electrodes 1531 and an electrode 1533. The enclosed capsule 1520 includes liquids 7 (e.g., water), liquid 8 (e.g., oil), a substrate 1525 and a hydrophobic dielectric layer 1523 are surfaces that repel liquids. A hydrophobic dielectric post 1521 is a support member as shown in FIG. 15B, but is not shown in FIG. 15A for ease of illustration. The hydrophobic post 1521 in some examples, is used to establish an initial flat film of the liquid 8 (oil) in the absence of a voltage from feedback controller 1510. The enclosed capsule 1520 also includes array electrodes 1531 and electrode 1533, which may be transparent.

The electrodes of the array electrode 1531 are individually controllable by the feedback controller 1531 in response to control signal provided by a microprocessor (such as microprocessor 123 of host system 115. The feedback controller 1510 in response to signals from the capacitance sensors 1538 manipulates the voltages applied to the array electrodes 1531 to maintain the standing wave in liquids 7 and 8.

In an example, an initial high voltage is applied by the feedback controller 1510 at a specific electrode in the array electrodes 1531 to dewet the liquid 8 (oil) so that the oil begins to rise away from the hydrophobic layer 1523. However, before the oil completely dewets the hydrophobic dielectric layer 1523 (which is determined based on the capacitance between the water and electrode according to measurements by the capacitance sensor 1538), the voltages applied to the array of electrodes 1531 are switched back to a lower voltage to undewet the hydrophobic dielectric surface 1523. This process is performed over multiple instances such that the thickness of liquid 8 (oil) at that particular electrode in the array of electrodes 1531 will reach a substantially stable thickness at a particular electrode of the array of electrodes 1531. As a result, a standing wave lens structure may be achieved. In another example, a moving wave lens structure may be achieved by dynamically controlling the voltage to the patterned electrodes of the array of electrodes 1531.

It should be noted that the geometry of the oil/water interface is not limited to prism shaped as shown in above figure, the provided lens geometries could be any combination of vertically oriented convex and concave oil geometries as long as there are adequate electrodes, the aspect ratio is not too great, and control signals provided to the feedback controller 1510 provide the selected spatial modulation.

It is also envisioned that lens geometries may also be create that will move horizontally (e.g., left to right through the enclosed capsule 1520) with time. For example, voltages at a particular frequency and timing may be applied to individual electrodes of the array electrodes 1531 to generate standing waves in a time sequence, such that the standing waves appear as a constant lens geometry.

FIG. 15B illustrates a top view of electrowettable lens example of FIG. 15A. The electrowettable lens 1500, as do similar electrowettable lens in FIGS. 13A-14B, includes transparent surfaces and electrodes that do not add significant optical processing (e.g., refraction) to the light output from the respective lenses. As a result, the number of array electrodes 1531 in electrowettable lens 1500 under control of the feedback controller 1510, or a processor, such as microprocessor 123 of host processor 115, may provide complex wavefronts in various directions to provide the selected spatial modulation.

Other examples of spatial distribution and light generation systems are also envisioned. These other systems may incorporate other variations of the previously described electrowettable lens.

The matrices of FIGS. 13A-15B may be configured to process the input light by providing only beam shaping or beam steering. In order to obtain both beam shaping and beam steering, the respective matrices may be stacked so that light processed by a first pixel matrix (e.g., 1300A) may be further processed by a second pixel matrix (e.g., 1400A). For example, a light source may be stacked on a beam shaping pixel matrix, which is further stacked on a beam steering matrix. The light source may output to the beam shaping pixel matrix which shapes the beam of input light according to a control signal. The shaped light beam is output from the beam shaping matrix to the beam steering pixel matrix. The beam steering pixel matrix in response to a control signal attains a beam steering state that provides the desired beam steering angle. As a result, the light output from the system, such as 111 or 711, provides, for example, a selected general illumination having the combination of beam shaping and beam steering.

Of course, other pixel matrix stacking configurations are possible, such as beam steering on beam shaping, multiple beam steering matrices on top of one another, or the like. For example, multiple beam steering matrices may be stacked to obtain greater angular deflection, such as a “wall wash” general illumination pattern or greater than 60 degrees from vertical. In addition, the stacked matrices may be set to a state that permits the light to pass through without applying any beam shaping or beam steering. Or said differently, one or more of the stacked matrices permit the light to pass through unprocessed. While the above discussion mentioned only two stacked matrices, it is envisioned that more matrices may be stacked together to obtain the selected image display and general illumination distribution characteristics.

In addition, the respective matrices may also provide a combination of beam shaping and beam steering. An example of this combination of capabilities, a pixel matrix may include a number of beam shaping pixels and a number of beam steering pixels. Since each pixel is individually controllable, the respective beam shaping pixels of the combined matrix may receive one or more control signals that indicate the desired beam shaping, while the respective beam steering pixels of the same combined matrix may receive one or more control signals different from the control signals provided to the beam shaping pixels. Therefore, combination matrices may be formed to provide different light processing effects.

Other methods of using electrowetting lenses for beam steering and shaping are also envisioned with respect to the examples of FIGS. 13A-15B. For example, the electrowettable lenses may be reflective. In an example, a reflective thin film (e.g. a mirror) may be disposed in between two liquids (e.g. oil and water), large scale beam steering could be achieved. In this case, the steering angle of reflective thin film may be determined by the contact angle between the two liquids, which may be electrically controlled. Incident light may be reflected by the reflective thin film, and the reflected angle is determined by the contact angle between the two liquids.

In another example, the electrowettable lenses may be transmissive. In an example of a transmissive electrowettable lens, an optical transparent thin film with graded (i.e., gradually changing) refractive index may be added in between of two liquids (e.g. oil and water). The light incident on the thin film will pass through it. The refractive index of the thin film may change gradually from the oil to the water, which may help to decease the Fresnel loss. For example, the thin film may be a stack of graded refractive index material, or may be a thin film with periodic nanostructures that provide an effective graded refractive index.

In addition to the electrowettable implementations discussed above, other examples of pixel spatial light modulators may incorporate one or more technologies such as liquid crystals (LC); polarization gratings (PG); LCPG; micro/nano-electro-mechanical systems (MEMS/NEMS)), such as a tip/tilt/piston (TTP) NEMS/MEMS based dynamic optical beam control that may be active control using one or more controllable lensing, reflectors and mirrors; electrowetting; microlens array; electrowetting based dynamic optical beam control; vertical continuous optical phased array (V-COPA); volume holographic step steering; birefrigent prisms; microlens based passive beam control; passive control using segment control (X-Y area and pixels), holographic films, LCD materials and/or electrophonic. Of course, these spatial modulation technologies are given by way of non-limiting examples, and other spatial modulation techniques may be used. Other techniques, such as 3 dimensional (3D) techniques, may be utilized to provide enhanced image display and general illumination distributions. It is envisioned that different display image presentation techniques that allow viewers in different locations of a space may view a lighting device and see different attributes of the lighting device. A view directly beneath the lighting device may only see in the displayed image the bezel surrounding a light source, such as a light bulb, of the selected image of a luminaire, while another viewer some distance away may see a side view image of the selected image of the luminaire. Examples of such displays and display techniques may be provided by Zebra Imaging of Austin, Tex., and Leia Inc. of Menlo Park, Calif.

Also, as mentioned above, the spatial modulators may incorporate one or more technologies. In more detail, a spatial modulator may utilize light scattering based beam shaping devices. Light scattering based beam shaping devices, in contrast to beam steering technologies discussed above, include several technologies that accomplish rudimentary beam shaping by electrically controlled optical scattering. Examples of the light scattering technologies include electro-chromic materials, electrophoretic inks (e-ink), polymer dispersed liquid crystals (PDLCs), polymer stabilized cholesteric texture liquid crystals (PSCT-LCs) that are more commonly used for smart window and privacy window type applications. All these technologies are available either as embedded in glass or as separate films easily laminated on glass. In all cases, applied voltage can be used to control the diffusivity of the film/glass. In one example, the glass/film has two discrete states: a first state that is completely transparent and does not alter the source beam shape, and a second state that is completely diffuse such that the incoming light is scattered into random directions uniformly. In another examples, the diffusivity can be varied by controlling value of the applied voltage. For some of these technologies, such as PSCT-LCs, the two discrete states are bistable i.e. no voltage is required to maintain the extreme states and voltage is only required to control the switching in between. In addition, pigments may be added the PSCT-LC to provide color control. Also, in all of the examples, electrodes may be arrayed (i.e., pixelated) using individual transistor, such as thin film transistor (TFT), control to address individual sections and provide greater control such as providing patterns of light on a display surface.

Another example of a spatial modulator includes cascaded passive optics. Cascaded passive optics is a sub category of techniques using mechanical motion of passive optics to achieve continuous beam steering. In one example, continuous beam steering may be achieved by positioning and moving one or more two-dimensional (2D) micro-lens arrays in a particular plane of motion to continuously steer the beam. Other passive optical films that may be used include micro-prisms, diffraction gratings, and/or combinations of such optics.

In addition to or alternatively from cascaded passive optics, passive control may be obtained using segment control via, for example, an X-Y area and pixels. This control approach achieves beam steering by using multiple LEDs coupled to corresponding multiple passive optics. The assumption here is the cost of using and driving multiple LEDs in conjunction with passive optics is less expensive than similar active optics to achieve the same effect. For example, if a particular brightness and/or color is selected, an M×N array of LEDs are desired for the luminaire operation to achieve the selected brightness and/or color, the resolution of the LED array may be increased to (K*M×L*N), where K*L is the number of beam steering/beam shaping stages. In such an example, each K×L “sub-pixel” consists of individual LEDs coupled to corresponding passive lens/prism/diffraction grating/other passive optic to provide the respective beam shaping/beam steering function. Therefore within the K×L array, some passive optics may have a first set of attributes (lens=focal length A, prism=wedge angle B, diffraction grating=period C, wavelength D, or the like) and other passive optics in the same K×L array will have a second set of attributes (lens=focal length B, prism=wedge angle A, diffraction grating=period J, wavelength C, or the like). Of course, the number of sets of attributes for the passive optics is not limited. For example, an array may have passive optics having one set, ten sets or tens of thousands of sets of different attributes.

Also suitable as spatial modulators are volume holograms. Volume holograms are “thick” diffraction gratings that are highly efficient, highly wavelength selective, highly angle selective beam steering devices capable of providing large angle beam steering. Due to their wavelength/angle sensitivity and passive nature, volume holograms are usually used in combination with other small angle active beam steering approaches, such as liquid crystal based approaches, to collectively provide large angle beam steering. For example, several volume holograms, such as 10 s-100 s of volume holograms, may be stacked together to cover large angle and wavelength ranges. In addition to large angle beam steering, volume holograms can be used to provide complex beam shapes by appropriately recording such patterns in a recordable optical medium material. Examples of recordable optical medium materials include photo-thermal refractive glass, holographic polymer dispersed liquid crystals (HPDLCs), or the like.

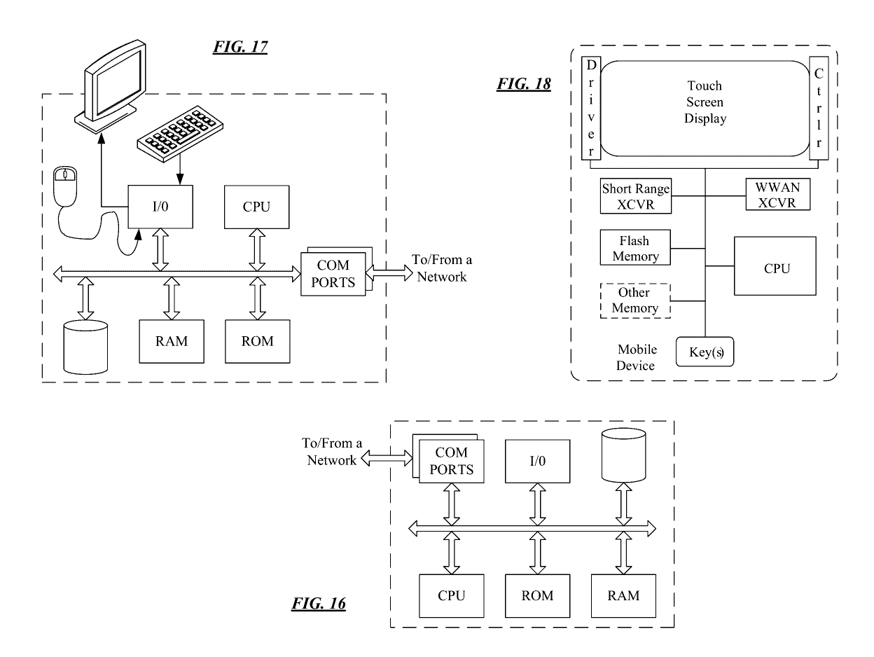

FIG. 16 illustrates a network or host computer platform, as may typically be used to generate and/or receive lighting device 11 control commands and access networks and devices external to the lighting device 11, such as host processor system 115 of FIG. 1. FIG. 17 depicts a computer with user interface elements, such as those user input devices that may be coupled to communication 117 shown in FIG. 1, although the computer of FIG. 17 may also act as a server if appropriately programmed. The block diagram of a hardware platform of FIG. 18 represents an example of a mobile device, such as a tablet computer, smartphone or the like with a network interface to a wireless link, which may alternatively serve as a user terminal device for providing a user experience. It is believed that those skilled in the art are familiar with the structure, programming and general operation of such computer equipment and as a result the drawings should be self-explanatory.

A server (see e.g. FIG. 16), for example, includes a data communication interface for packet data communication via the particular type of available network. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load. A server, such as that shown in FIG. 16, may be accessible or have access to a lighting device 11 via the communication interfaces 117 of the lighting device 11. For example, the server may deliver in response to a user request a configuration information file. The information of a configuration information file may be used to configure a software configurable lighting device, such as lighting device 11, to set light output parameters comprising: (1) light intensity, (2) light color characteristic and (3) spatial modulation, in accordance with the lighting device configuration information. In some examples, the lighting device configuration information include an image for display by the lighting device and at least one pixel level setting for at least one of beam steering or beam shaping by the lighting device. The configuration information file may also include information regarding the performance of the software configurable lighting device, such as dimming performance, color temperature performance and the like. The configuration information file may also include temporal information such as when to switch from one beam shape or displayed image to another and how long the transition from one state to another should take. Configuration data may also be provided for other states, e.g., for when the virtual luminaire is to appear OFF, in the same or a separate stored data file.

A computer type user terminal device, such as a desktop or laptop type personal computer (PC), similarly includes a data communication interface CPU, main memory (such as a random access memory (RAM)) and one or more disc drives or other mass storage devices for storing user data and the various executable programs (see FIG. 16). A mobile device (see FIG. 17) type user terminal may include similar elements, but will typically use smaller components that also require less power, to facilitate implementation in a portable form factor. The example of FIG. 18 includes a wireless wide area network (WWAN) transceiver (XCVR) such as a 3G or 4G cellular network transceiver as well as a short range wireless transceiver such as a Bluetooth and/or WiFi transceiver for wireless local area network (WLAN) communication. The computer hardware platform of FIG. 16 and the terminal computer platform of FIG. 17 are shown by way of example as using a RAM type main memory and a hard disk drive for mass storage of data and programming, whereas the mobile device of FIG. 18 includes a flash memory and may include other miniature memory devices. It may be noted, however, that more modern computer architectures, particularly for portable usage, are equipped with semiconductor memory only.

The various types of user terminal devices will also include various user input and output elements. A computer, for example, may include a keyboard and a cursor control/selection device such as a mouse, trackball, joystick or touchpad; and a display for visual outputs (see FIG. 17). The mobile device example in FIG. 18 uses a touchscreen type display, where the display is controlled by a display driver, and user touching of the screen is detected by a touch sense controller (Ctrlr). The hardware elements, operating systems and programming languages of such computer and/or mobile user terminal devices also are conventional in nature, and it is presumed that those skilled in the art are adequately familiar therewith.

The user device of FIG. 17 and the mobile device of FIG. 18 may also interact with the lighting device 11 in order to enhance the user experience. For example, third party applications maintained in flash memory or other memory of the mobile device of FIG. 18 may correspond to control parameters of a software configurable lighting device, such as spatial modulation and In addition in response to the user controlled input devices, such as I/O of FIG. 17 and touchscreen display of FIG. 18, the lighting device, in some examples, is configured to accept input from a host of sensors, such as sensors 121. These sensors may be directly tied to the hardware of the device or be connected to the platform via a wired or wireless network. For example, a daylight sensor may be able to affect the light output from the illumination piece of the platform and at the same time change the scene of display as governed by the algorithms associated with the daylight sensor and the lighting platform. Other examples of such sensors can be more advanced in their functionality such as cameras for occupancy mapping and situational mapping.

The lighting device 11 in other examples is configured to perform visual light communication. Because of the beam steering (or steering) capability, the data speed and bandwidth can have an increased range. For example, beam steering and shaping provides the capability to increase the signal-to-noise ratio (SNR), which improves the visual light communication (VLC). Since the visible light is the carrier of the information, the amount of data and the distance the information may be sent may be increased by focusing the light. Beam steering allows directional control of light and that allows for concentrated power, which can be a requirement for providing highly concentrated light to a sensor. In other examples, the lighting device 11 is configured with programming that enables the lighting device 11 to “learn” behavior. For example, based on prior interactions with the platform, the lighting device 11 will be able to use artificial intelligence algorithms stored in memory 125 to predict future user behavior with respect to a space.

As also outlined above, aspects of the techniques form operation of a software configurable lighting device and any system interaction therewith, may involve some programming, e.g. programming of the lighting device or any server or terminal device in communication with the lighting device. For example, the mobile device of FIG. 18 and the user device of FIG. 17 may interact with a server, such as the server of FIG. 16, to obtain a configuration information file that may be delivered to a software configurable lighting device 11. Subsequently, the mobile device of FIG. 18 and/or the user device of FIG. 17 may execute programming that permits the respective devices to interact with the software configurable lighting device 11 to provide control commands such as the ON/OFF command or a performance command, such as dim or change beam steering angle or beam shape focus. Program aspects of the technology discussed above therefore may be thought of as “products” or “articles of manufacture” typically in the form of executable code and/or associated data (software or firmware) that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software or firmware programming. All or portions of the programming may at times be communicated through the Internet or various other telecommunication networks. Such communications, for example, may enable loading of the software from one computer or processor into another, for example, from a management server or host computer of the lighting system service provider into any of the lighting devices, sensors, user interface devices, other non-lighting-system devices, etc. of or coupled to the system 11 via communication interfaces 117, including both programming for individual element functions and programming for distributed processing functions. Thus, another type of media that may bear the software/firmware program elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible or “storage” media, terms such as computer or machine “readable medium” refer to any medium that participates in providing instructions to a processor for execution.

The term “coupled” as used herein refers to any logical, physical or electrical connection, link or the like by which signals produced by one system element are imparted to another “coupled” element. Unless described otherwise, coupled elements or devices are not necessarily directly connected to one another and may be separated by intermediate components, elements or communication media that may modify, manipulate or carry the signals.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A lighting device, comprising:
a matrix display;
a display driver coupled to the matrix display, responsive to a first control input to drive the matrix to generate light representing an image;
a controllable optic array coupled to the matrix display to optically process the image light output from the display to shape and/or redirect image light from the display;
an optic driver coupled to the controllable optic array to drive a state of each pixel of the controllable optic array, responsive to a second control input;
a memory;
a processor having access to the memory and coupled to supply the first and second control inputs to the drivers; and
programming in the memory, wherein execution of the programming by the processor configures the lighting device to perform functions including functions to:
access an image selection and a general lighting distribution selection;
present an image output, based on the image selection, via the matrix display visible through the controllable optical array; and
emit light for general illumination having the selected general lighting distribution from at least a portion of the optic array.

2. The lighting device of claim 1, wherein execution of the programming by the processor further configures the lighting device to emit the light for general illumination having the selected general lighting distribution simultaneously with the image output.

3. The lighting device of claim 1, wherein the matrix display comprises:
a plurality of individually controllable light sources responsive to display driver control signals provided via the first control input.

4. The lighting device of claim 1, wherein the controllable optic array comprises:
a plurality of individually controllable pixels that in response to the received control signals redirect light or shape light beams from the matrix display for output of distributed light and/or image light.

5. The lighting device of claim 1, wherein the matrix display comprises:
a light generation source; and
a plurality of individually controllable color filters responsive to display driver control signals provided via the first control input.

6. The lighting device of claim 1, wherein the light generation source comprises a source selected from the group consisting of:
planar light emitting diodes (LEDs) of different colors;
a micro LED;
organic LEDs of different colors;
pixels of an organic LED display;
LEDs on gallium nitride (GaN) substrates of different colors;
nanowire or nanorod LEDs of different colors;
photo pumped quantum dot (QD) LEDs of different colors;
plasmonic LEDs of different colors;
pixels of a plasma display;
laser diodes of different colors;
micro LEDs of different colors;
resonant-cavity (RC) LEDs of different colors;
super luminescent diodes (SLD) of different colors; and
photonic crystal LEDs of different colors.

7. A lighting device, comprising:
a matrix display;
a pixel controllable source of general lighting illumination;
a controllable optic array coupled to the pixel controllable source to optically process the general lighting illumination from the pixel controllable source to shape and/or redirect image light from each pixel of the source,
wherein at least one of the matrix display and the pixel controllable source allow passage of light from the other;
a display driver coupled to the matrix display, responsive to a first control input to drive the matrix to generate light representing an image;
a driver coupled to the pixel controllable source and the controllable optic array, responsive to a second control input;
a memory;
a processor having access to the memory and coupled to supply the first and second control inputs to the drivers; and
programming in the memory, wherein execution of the programming by the processor configures the lighting device to perform functions including functions to:
access an image selection and a general lighting distribution selection;
generate an image output from the matrix display, based on the image selection; and
emit light for general illumination having the selected general lighting distribution from at least a portion of the controllable optic array,
wherein the image output and the light emission are sufficiently close in time as to appear as a combined image and general lighting output within a space illuminated by the lighting device.

8. The lighting device of claim 7, wherein execution of the programming by the processor further configures the lighting device to time division multiplex the light emission for general illumination and the image output during repetitions of a duty cycle, to emit the light for general illumination having the selected light distribution during a first portion of each repetition of the duty cycle and to generate the image output during a second portion of each repetition of the duty cycle distinctly different from the first portion of each repetition of the duty cycle.

9. The lighting device of claim 7, wherein:
execution of the programming by the processor further configures the lighting device to time division multiplex the light emission for general illumination and the image output, and
the processor:
controls a first region of the matrix display to emit light for displaying an image during a first portion of a duty cycle; and
controls a first region of the controllable optical array to permit the passage of the image light for output from the lighting device during the first portion of the duty cycle.

10. The lighting device of claim 7, wherein:
execution of the programming by the processor further configures the lighting device to time division multiplex the light emission for general illumination and the image output, the processor:
controls a first region of the matrix display to emit image light for general illumination; and
controls a first region of the controllable optical array to shape and/or redirect the image light for output from the lighting device as general illumination light.

11. A lighting device, comprising:
a pixel controllable light generation and pixel controllable spatial light distribution system including a number of pixels, wherein:
(a) each respective pixel of the light generation and distribution system comprises a plurality of individually controllable light generation sources; and
(b) each of the individually controllable light generation sources is configured within the respective pixel to emit light in a different angular direction;
a driver coupled to the controllable system to control at a pixel level light generation by the system and to control the sources in the pixels so as control at a pixel level spatial distribution of the generated light based on the angular direction of emitted light from respective pixels;
a memory;
a processor having access to the memory and coupled to control operation of the driver; and
programming in the memory, wherein execution of the programming by the processor configures the lighting device to perform functions including functions to:
obtain an image selection and a general lighting distribution selection as configuration file data;
present an image output, based on the image selection; and
simultaneously with the image output, emit light for general illumination having the selected light distribution.

12. The lighting device of claim 11, further comprising a pixel array of electrically controllable beam shaping elements, each pixel element of the array being optically coupled to shape light output of the individually controllable light generation sources of one or more pixels of the pixel controllable light generation and pixel controllable spatial light distribution system.

13. The lighting device of claim 11, wherein each of the individually controllable light generation sources within the respective pixel comprises one or more light emitters arranged on a slanted surface at a preset angle for emitting light in a different angular direction from another light generation source within the respective pixel.

14. The lighting device of claim 11, wherein:
each respective pixel further comprises a common planar surface for mounting each of the individually controllable light generation sources within the respective pixel; and
less than all of the individually controllable light generation sources within each respective pixel mounted on the common planar surface, comprise an optic that redirects generated light at a preset angle.

15. The lighting device of claim 11, wherein:
each source in each respective pixel comprises:
at least one light emitter;
one or more collimating lenses coupled to the at least one or more light emitters; and
a plurality of controllable color filters coupled to process collimated light output of the one or more collimating lenses to form the individually controllable light generation sources within the respective pixel; and
at least one of the individually controllable light generation sources within each respective pixel, further comprises an optic coupled to a respective controllable color filter configured to redirect generated light at a preset angle.

16. A lighting device, comprising:
a pixel controllable light generation matrix, wherein:
each respective pixel of the light generation and distribution system comprises a plurality of individually controllable light generation sources; and
each of the individually controllable light generation sources is configured within the respective pixel to emit light in a different angular direction;
a pixel controllable beam shaping array, wherein:
each respective pixel of the controllable beam shaping array comprises a plurality of individually controllable optics that redirect light in response to control signals;
an image driver coupled to the controllable light generation matrix to control at a pixel level light generation by the matrix;
a distribution control driver coupled to the controllable beam shaping array that controls at a pixel level spatial distribution of the generated light;
a memory;
a processor having access to the memory and coupled to control operation of the drivers; and
programming in the memory, wherein execution of the programming by the processor configures the lighting device to perform functions including functions to:
obtain an image selection and a general lighting distribution selection as configuration file data;
present an image output, based on the image selection and control signals sent to the image driver; and
simultaneously with the image output, emit light according to control signals sent to the distribution control driver for general illumination having the selected light distribution.

17. The lighting device of claim 16, wherein the pixel controllable light generation matrix comprises:
a plurality of pixels; and
each of the plurality of pixels comprises:
a plurality of individually controllable light generation sources, wherein:
each of the individually controllable light generation sources is configured within the respective pixel to emit light in an angular direction.

18. The lighting device of claim 16, wherein the pixel controllable light generation matrix comprises:
a plurality of pixels having individually controllable light generation sources, wherein the individually controllable light generation sources emit controllable combinations of colored light at a preset angle; and
wherein execution by the processor of programming stored in the memory further configures the processor to:
send control signals to each of the individually controllable light generation sources based on the configuration file data.

19. The lighting device of claim 16, wherein the image driver is configured to:
receive control signals from the processor based on the selected image;
distribute individual control signals to each of the individually controllable light generation sources for generating the selected image display.

20. The lighting device of claim 16, wherein the distribution driver is configured to:
receive control signals from the processor based on the selected light distribution;
distribute individual control signals to each of the individually controllable optics for generating the selected light distribution.

21. The lighting device of claim 16, wherein each pixel controllable beam shaping array comprises a light scattering based beam shaping device selected from one or more of electro-chromic materials, an electrophoretic ink, polymer dispersed liquid crystals, or polymer stabilized cholesteric texture liquid crystals.

22. A lighting fixture, comprising:
an image display; and
means for optically, spatially modulating light output from the image display to distribute the light output of the light fixture to emulate a lighting distribution of a selected one of a plurality of types of luminaire for a general illumination application of the one type of luminaire.

23. The lighting fixture of claim 22, wherein the modulating means further distributes the light output of the light fixture to present an image selected from a plurality of images, and the selected image is unrelated to the general illumination application.

24. A lighting device comprising at least one light fixture as recited in claim 22 and a programmable controller connected to control the means for modulating light of each light fixture.

25. A lighting fixture, comprising:
an image display; and
means for controlling a light output of the fixture including light output from the image display, to produce an illumination light in the output from the fixture having two or more performance parameters for a selected one of a plurality of types of luminaire for a general illumination application of the selected one type of luminaire.

26. The lighting fixture of claim 25, wherein the parameters include two or more of light intensity, a color characteristic of light, or light output distribution for the selected type of luminaire.

27. The lighting fixture of claim 25, wherein the means for controlling comprises an optical spatial modulator.

28. A lighting fixture of claim 27, wherein the optical spatial modulator comprises:
a plurality of individually controllable pixels that in response to the received control signals redirect light or shape light beams from the image display for output of distributed light and/or image light.

29. A lighting fixture of claim 25, wherein the means for controlling further comprises a controller coupled to control the image display and the optical spatial modulator.

30. The lighting fixture of claim 29, wherein the image display comprises:
a light generation source; and
a plurality of individually controllable color filters responsive to control signals provided by the controller.
